(19) United States
(12) Patent Application Publication
(10) Pub. No.: US 2018/0283559 A1
(43) Pub. Date: Oct. 4, 2018

(54) HYDRAULIC SYSTEM

(71) Applicant: GRUNDFOS HOLDING A/S, Bjerringbro (DK)

(72) Inventor: Thomas BLAD, Bjerringbro (DK)

(21) Appl. No.: 15/765,336

(22) PCT Filed: Sep. 30, 2016
(86) PCT No.: PCT/EP2016/073409

§ 371 Date: Apr. 2, 2018

(30) Foreign Application Priority Data
Oct. 2, 2015 (EP) 15188146.3

(51) Int. Cl. F16K 1/12; F16K 11/048; F16K 41/10; F24D 19/10; F24D 3/10

(52) U.S. Cl. CPC F16K 1/126; F16K 11/048; F24D 3/105; F24D 19/1024; F16K 41/10

(57) ABSTRACT

A method switches a switching device (4) between two switch positions in a hydraulic system. The hydraulic system apart from the switching device (4) includes a pump assembly (2). The pump assembly (2) can assume at least two different operating conditions. A switching-over of the switching device (4) is initiated by the pump assembly (2) via the hydraulic system. The switch positions of the switching device (4) are reached depending on a stay duration of the pump assembly (2) in at least one of the two operating conditions. Further, a hydraulic system for carrying out the method is provided.

### CROSS REFERENCE TO RELATED APPLICATIONS

This application is a United States National Phase Application of International Application PCT/EP2016/073409, filed Sep. 30, 2016, and claims the benefit of priority under 35 U.S.C. § 119 of European Application 15 188 146.3, filed Oct. 2, 2015, the entire contents of which are incorporated herein by reference.

### FIELD OF THE INVENTION

The invention relates to a method for switching over a switching device between two switch positions in a hydraulic system, which apart from the switching device comprises a pump assembly. The invention moreover relates to a corresponding hydraulic system which is suitable for carrying out this method.

### BACKGROUND OF THE INVENTION

The most varied of switching devices are used in hydraulic systems, in order for example to close flow paths or switch between different flow paths. Thus for example in hydraulic heating systems which are used for heating a building as well as for heating service water, it is known to apply a switching device in the form of a switch-over valve which selectively leads the heating medium flow through the building or a heat exchanger for heating the service water. As a rule, separate drives are necessary for such switching devices, which render the switching devices relatively complicated with regard to their construction, and expensive.

Moreover, switching devices such as relief valves which switch by way of a change of the pressure are known. Such switching devices however cannot be used for switching between two flow paths for example, since the flow could then only be led through the one flow path at a low pressure. Moreover, switch-over devices are known, which are actuated byway of a rotation direction reversal of a pump assembly. With these systems, it is disadvantageous that the efficiency of the pump assembly is not the same in both rotation directions, and that the valve needs to be arranged in the proximity of the impeller.

### SUMMARY OF THE INVENTION

With regard to these problems, it is an object of the invention to provide a method for switching over a switching device in a hydraulic system, as well as a corresponding hydraulic system which permits a switching device to be switched between two switch positions at a high efficiency and in a simple manner.

The method according to the invention serves for switching a switching device between two switch positions, wherein the switching device is arranged in a hydraulic system which apart from the switching device, comprises a pump assembly. According to the invention, the pump assembly is utilized, to initiate the switching device into switching between the switch positions. A purely hydraulic coupling of the pump assembly to the switching device via the hydraulic system itself, which is to say via the fluid delivered in the hydraulic system, is preferably envisaged for this. This means that no separate control connections or signal connections are necessary between the pump assembly and the switching device. The switching device for example can comprise one or more movable switching elements which can be moved between different positions, in particular between at least two possible switch positions.

According to the invention, the pump assembly has at least two different operating conditions. For this, the pump assembly is preferably provided with a control device which can set these two operating conditions. The pump assembly can preferably be a circulation pump assembly with an electronically activated drive motor, in particular a drive motor which is activated via a frequency converter, wherein the control device activates the drive motor. As described, according to the invention, a switching of the switching device is initiated by the pump assembly via the hydraulic system itself. According to the invention, one thereby envisages the switch positions of the switching device being achieved in a manner dependent on the stay duration of the pump assembly in at least one of the two operating conditions. This for example means that the pump assembly, if it remains for a longer time interval in a second operating condition, switches into the one switch position, and if it remains in this second operating condition for a shorter time interval, it switches into the other switch condition which is to say the other switch position or remains in this switch position. A predefined time interval for the operation in the respective operating condition and which is necessary for switching over is preferably stored in the control device. This means that the one switch position is reached if the operational duration in the operation conditional is shorter than the time interval, and the other switch position is reached if the operational duration is longer than the time interval.

Particularly preferably, two different operating conditions are envisaged, wherein a first operating condition is that operating condition, in which the pump assembly is operated in normal operation of the hydraulic system. The pump assembly can then be brought into a second operating condition for switching over the switching device, wherein the switching device is switched over as desired in a manner dependent on the time interval, in which the pump assembly stays in the second operating condition. In particular, the method can be configured such that the switching device switches over given a certain stay duration, and does not switch over or switches over and switches back again into the first switch position, given another stay duration. A desired switch position of the switching device can therefore be achieved in a manner depending on the stay duration in the second operating condition.

According to a preferred embodiment of the method according to the invention, the switching device is self-holding in each of the two switch position, on operation of the pump assembly in a first operating condition. The switching device in the first operating condition is preferably held in the respective switch position by a hydraulic pressure produced by the pump assembly. The pump assembly is brought out of the first operating condition into the second operating condition for switching between the switch positions of the switching device, wherein the self-holding function is lifted in this second operating condition. In particular, this can be effected by way of reducing the hydraulic pressure in the system. The switching device is switched to and fro between the two switch positions in this second operating condition of the pump assembly. For holding a desired switch position, the pump assembly, exactly when the desired switch position is reached, is brought again into the first operating condition, in which the switch position is again automatically held, for example by way of the hydraulic pressure. This means that the pump assembly in one of the two possible switch positions of the switching device is brought again into the first operating condition, depending on how long the pump assembly is operated in the second operating condition, so that the switching device is switched precisely into this switch position and then held again.

Particularly preferably, the pump assembly in the first operating condition is operated at a higher speed than in the second operating condition. A greater hydraulic pressure is produced in the hydraulic system in the first operating condition than in the second operating condition by way of this. Further preferably, the speed in the first operating condition is larger than a defined limit speed and in the second operating condition is smaller than or equal to the limit speed. Alternatively, the pump assembly can be switched off, which is to say can be at a standstill, in the second operating condition. Such a limit speed can be stored in the control device. Thereby, the limit speed is selected such that the desired self-holding function is given above the limit speed, and this self-holding function is no longer given below or at the limit speed, in order to permit the switching of the switching device to and fro, which is to say a switching-over of the switching device.

Further, one preferably envisages the switch device being moved into a defined starting position and being held there, on operation of the pump assembly in the second operating condition and/or at standstill of the pump assembly. This can be effected by a restoring element such as a restoring spring.

The switching device preferably assumes each of the two switch positions at least once when the switching device switches to and fro between the two switch positions. Thus by way of switching the pump assembly over into the first operating condition, it is possible to select the desired of the two switch positions, depending on the point at time, at which the pump assembly is switched into the first operating condition. The time durations for the switching to and fro are preferably known by a control device, so that the point in time for switching over the pump assembly into the first operating condition can be exactly defined.

Particularly preferably, the switching of the switching device to and fro is effected with the help of energy which has been previously stored on operation of the pump assembly in the first operating condition in at least one energy store and/or in the hydraulic system itself and/or is released to the hydraulic system by the pump assembly in the second operating condition. One can therefore make do without a separate drive of the switching device for moving a switching element of the switching device. Instead, the movement is preferably initiated by the hydraulic energy from the hydraulic system itself. Particularly preferably, the switching energy which is required for this is stored during the first operating condition and then utilized in the second operating condition of the pump assembly, in order to effect the switching-over which is to say the to and fro movement.

An energy store for example can be configured as spring storage means. Energy can be stored in the hydraulic system itself, for example as flow energy of the fluid flowing in the system. The fluid with its movement has a certain inertia and thus on switching over into the second operating condition of the pump assembly still has a certain energy, which it has absorbed in the first operating condition. In particular, the pressure in the system reduces more quickly than the flow energy given a reduction of the speed. Therefore, if the pressure is utilized for holding the switching device in a certain switch position, then this pressure can be very rapidly reduced for lifting the holding function, whilst sufficient flow energy is still present in the system, in order to be able to effect the switching-over of the switching device.

According to a further preferred embodiment, a movement between the two switch positions of the switching device or of a switching element of the switching device with the to and fro switching is delayed via at least one damping element and/or a path distance to be covered. This permits the switching to and fro to be delayed in a manner such that sufficient time remains, precisely in a certain switch position, which is to say at a defined point in time, to bring the pump assembly into the first operating condition, in order to hold the switching device in the desired switch position.

According to a preferred embodiment of the invention, the switching device comprises at least one damping device which is configured and acts in a manner such that it damps a direct impact of the switching device on reaching at least one of the two switch positions, i.e. damps the impact. In particular, the damping device preferably acts such that it permits a certain movement of the switching device beyond the reaching of the switch position. A direct rebounding or bouncing back from the reached switch position is prevented by way of this. In particular, such a damping device is useful if the switching device is moved solely by the inertia force of the fluid which flows in the system. With such a design of the switching device, the switching device preferably comprises two coupled valve elements which are freely movable together. One can prevent the valve element from hitting the valve seat and rebounding from this again by way of the damping device. The damping element can be configured as an elastically deformable element, for example as an elastic bellows or as an elastic valve seat. According to a preferred embodiment, it can be configured as a bellows, whose inner volume is open to the outside via a throttle location. An additional damping can therefore be achieved via the throttle. Alternatively or additionally, the damping element can be configured as a hydraulic damping element, for example by way of a piston moving in a cylinder, so that a volume in the cylinder is reduced and a liquid which is located in the volume is displaced through a throttle out of the volume. Therein, the throttle in particular can be formed by a gap between the piston and the surrounding cylinder wall. Herein, the piston can further preferably be formed by the valve element itself. Further preferably, the valve element can be configured such that with regard to its movement direction, it seals radially close to a sealing end position and comes to axially bear on a valve seat given a further movement.

The switching device can preferably comprise at least one linearly movable valve body or a linearly movable valve element, said body or element in a switch position sealingly bearing on an associated valve seat and being configured in a manner such that the valve body, with its movement, passes an annular wall which surrounds the outer periphery of the valve body and reduces the flow cross section, before reaching the valve seat. The annular wall herein extends parallel to the movement axis of the valve body. The annular wall forms a cross-sectional reduction of the flow path which is essentially closed by the passing valve body. The valve body can therefore in particular seal radially against the annular wall. The valve body can close the flow path through the valve seat before it comes to axially bear on the valve seat. The preferably cylindrical annular wall thereby comprises a cross section which is preferably slightly larger than the cross section of the valve body transverse to its movement direction.

The valve element or the valve body can therefore immerse for example into a surrounding cylinder and thus close the flow path through the cylinder whilst it can still move further by a certain amount in the direction of the longitudinal axis of the cylinder, before it axially abuts a valve seat. The switch position, in which the flow path is closed, is therefore reached before the movement of the valve element is stopped. This means that the impact is damped.

The described damping device has the effect that there is not only a short closure moment with the striking of the valve element or valve body on the valve seat, but that there is a longer closure time interval, in which the closure of the flow path is essentially given. The pump assembly can then be switched again into its first operating condition within this closure time interval. This means that a larger time window for the switching-over of the operating condition of the pump assembly for holding the switch position of the switching device is created by the damping device.

In the case that two coupled valve elements are provided, both valve elements can be coupled to corresponding damping devices. However, it is also possible to provide only one damping device which damps the impact of only one of the valve elements on its valve seat.

In a further preferred development of the method, the switching device is a switch-over device which switches between two flow paths for a flow produced by the pump assembly, wherein preferably a hydraulic pressure produced by the pump assembly in the just closed flow path is utilized to hold the switching device in its assumed switch position, as long as the pump assembly is operated in its first operating condition. For this, the switching device is preferably configured such that its switching element must be moved against the mentioned hydraulic pressure for opening the flow path. A self-holding function is thus created.

The subject-matter of the invention, apart from the previously described method, is a hydraulic system with at least one pump assembly and with a switching device having at least two different switch positions. I.e. at least one movable switching element of the switching device has at least two switch positions. The pump assembly simultaneously has at least two different operating conditions and the switching device is connected to the pump assembly via a hydraulic connection, preferably exclusively via a hydraulic connection. This is preferably that hydraulic connection, through which a fluid is delivered by the pump assembly. According to the invention, the switching device is moreover configured such that the switch positions of the switching device or of its switching elements can be reached in a manner depending on the stay duration of the pump assembly in at least one of the two operating conditions. The above description of the method is referred to concerning the manner of functioning. The hydraulic system according to the invention serves for implementing the method. It is to be understood that device features resulting from the preceding description of the method are likewise preferred designs of the hydraulic system, and procedures of the method which are simultaneously described hereinafter by way of the hydraulic system can be preferred method steps of the method according to the invention.

Particularly preferably, the switching device or at least a switching element of the switching device has two switch positions and the switching device is configured in a manner such that the switching device is self-holding in each of the two switch positions, on operation of the pump assembly in a first operating condition. This means that no external drive is necessary for holding the switch positions. The holding of the switch positions, as described above, is preferably effected by the hydraulic pressure in the system. Further preferably, the pump assembly as well as the switching device are configured in a manner such that for switching between the switch positions, they interact in a manner such that in a second operating condition of the pump assembly, the switch device switches to and fro between the two switch positions, and for holding a desired switch position the pump assembly is brought into the first operating condition on reaching the desired switch position. This means that the self-holding function is lifted by way of operation of the pump assembly in the second operating condition. A to and fro movement of the switching device between the possible switch positions is simultaneously initiated, so that the self-holding function can be put in operation again by way of a targeted re-switching of the first operating condition at a certain point in time, at which the switching device or its switching element is situated in a desired switch position, so that the switching device again is then held in this switch position in a stable manner.

As described above, the pump assembly is preferably configured such that its drive motor can be set or closed-loop controlled in its speed. The pump assembly preferably comprises a suitably configured control device for this. The pump assembly is further preferably configured such that in the first operating condition, the pump assembly is operated at a speed above a limit speed and that in the second operating condition of the pump assembly is operated at a speed smaller or equal to the limit speed or is at a standstill. The respective limit speed can be stored in a control device which sets the speed of the pump assembly and also initiates the switching-over of the switching device. Thereby, the limit speed is selected such that below the limit speed, the hydraulic pressure is preferably so small, that the switching device is no longer automatically held by the hydraulic pressure.

According to a further preferred embodiment, the switching device is provided with a drive element which in the second operating condition of the pump assembly switches the switching device to and fro between the two switch positions. The switching to and fro between the switch positions means that each of the two switch positions is reached preferably at least once. This e.g. means that if the switching device is initially situated in a first switch position, the switching device switches at least once into the second switch position. Further preferably, it then yet switches from the second switch position at least once back into the first switch position. The pump assembly thus at the first or second switch position can be brought again into the first operating condition in a targeted manner, in order to then hold the switch position in the described manner. The drive element is preferably a drive element which is supplied with energy from the hydraulic system which is to say energy which is provided by the pump assembly.

According to a further preferred embodiment, the drive element is configured in a manner such that it is movable by a force which is caused by a hydraulic flow, in particular by a hydraulic inertia force in the hydraulic system and/or comprises an energy store which is configured in a manner such that it stores energy or switching energy from the hydraulic system on operation of the pump assembly in the first operating condition, and releases this energy or switching energy on operation of the pump assembly in the second operating condition, by way of which energy the switching device is moved. The fluid flowing in the flow path has a kinetic energy which it still yet retains for a certain while even on switching off the pump assembly or with a reduction of the speed of the pump assembly. This energy can be utilized as switching energy, in order to move the switching device or the switching element of the switching device to and fro in the described manner. This is particularly possible, since the pressure in the system reduces more quickly than the kinetic energy of the fluid, on reducing the speed of the pump assembly. The self-holding function of the switching device can thus be lifted very quickly by way of reducing the pressure, whilst sufficient energy is still present in the system due to the inertia of the flowing fluid, in order to switch over the switching device. The drive element can be configured in the form of impact surfaces or catches, upon which the flow acts.

Alternatively or additionally, the switching device can be provided with an additional energy store, for example a spring storage means, a magnetic and/or pneumatic energy store. Such an energy store can be subjected to pressure in the first operating condition, and absorb energy from the hydraulic system, which energy it then releases again in the second operating condition, in order to switch the switching device to and fro in the described manner.

As described above, the switching device is preferably configured in a manner such that it switches at least once into each of the two switch positions, on operation of the pump assembly in the second operating condition.

According to a further preferred embodiment, the switching device can comprise a restoring element, for example a restoring spring, which is configured in a manner such that the switching of the switching device to and fro ends in a defined starting position of the switching device, and holds the switching device in this defined starting position given a standstill of the pump assembly. It can be ensured that the switching device is always situated in a defined switching position on starting operation of the pump assembly, by way of this.

The hydraulic system preferably comprises a control device, in particular an electronic control device, which is configured in a manner such that it firstly brings the pump assembly out of the first operating condition into the second operating condition on the basis of a switching command for switching over the switching device from the first into the second switching position, and brings the pump assembly back again into the first operating condition after a defined time interval which is matched to the time duration of the to and fro movement of the switching device in a manner such that the switching device is situated in the second switch position when the pump assembly is brought again into the first operating condition. Thus a switch-over into the second switch position condition is therefore rendered possible, departing from the first switch position. The control device is particularly preferably integrated into the control and/or regulation electronics of the pump assembly which are present in any case. Thus the electronics for the control or regulation of the pump assembly and which are present in any case can be used, in order to switch the switching device from a first switch condition into a second switch condition.

The hydraulic system is preferably configured such that the pump assembly comprises a speed controller for changing the speed of the pump assembly, wherein the speed controller preferably comprises a braking circuit which actively brakes the pump assembly with a reduction of the speed. Such a speed controller can be integrated into the control device of the hydraulic system or of the pump assembly and can preferably comprise a frequency converter. Such a braking circuit means that given a reduction of the speed, the pump assembly not only runs out, but is also actively braked by way of a suitable subjection of the coils of the electric drive motor to current. This is particularly advantageous if the energy for the operation of the drive element is to be taken from the hydraulic flow in the system. The hydraulic pressure is reduced rapidly due to a particularly rapid reduction of the speed which such a braking circuit renders possible, whereas the flow is still retained for a short time due to the mass inertia of the fluid. Thus the energy of this flow can be utilized, in order to move the drive element, whilst a hydraulic pressure which can be used to hold the switching device in the desired switch position has already fallen away.

The hydraulic system according to the invention and the method according to the invention can be applied for the most varied of application purposes. A switching device for example can serve for switching over between two flow paths in a hydraulic system, for example in systems, which distribute fluids to different tapping locations, cleaning systems, spring wells with different exit nozzles which are not operated at the same time, and in particular in heating installations. Thus in compact heating installations, it is common to provide two circuits, a heating circuit which runs through the radiators of the building, and a circuit which runs through a heat exchanger for heating service water. One can switch between these heating circuits with the help of a switching valve, which is to say a switching device. The system according to the invention and the method according to the invention permit the switch-over by way of a special operation of the pump assembly in this system, so that one can make do without a separate drive motor for a switch-over valve.

If the energy for driving a drive element of the switching device is to be taken from the hydraulic system, be it that the energy is stored in a separate energy store or however the energy is provided in the form of kinetic energy of the flow fluid, it is advantageous for the switching device in a first switch position, which corresponds to the idle position on starting operation of the system, to be situated in a position, in which the circuit through the heat exchanger for heating the service water is open and the heating circuit is closed. This is advantageous since the circuit through the heat exchanger is a defined and known circuit which as a rule is always situated in an unchanged hydraulic condition. This circuit as a rule is formed in a boiler itself and is known on the part of the manufacturer. The heating circuit through the building in contrast is not known with regard to its exact formation and comprises a multitude of valves, whose valve positions are not known, so that the flow through this circuit is also not known. If the circuit through the heat exchanger is opened in the first switch position, it is thus ensured that adequate energy is always present in the system in this first switch position, in order to be able to drive the drive element for switching into the second switch position.

If the switching device is automatically held in one of its switch positions by the hydraulic pressure in the system, then the occurring holding force can be adapted by way of adapting the size of the pressure surface, upon which the hydraulic pressure acts. In this case too, the drive element can be moved by the hydraulic flow in the system, and impact or pressure surfaces of the drive element adapted with regard to their size, in order to change the occurring forces for moving the switching device. The switching device can therefore be adapted to a special hydraulic system, by way of the surfaces, upon which hydraulic pressures or flows act, being dimensioned such that the desired force conditions are produced for holding and/or moving the switching device.

Further preferably, the switching device is integrated together with a pump assembly into a hydraulic block or hydroblock for a heating facility. Such hydraulic blocks form integrated hydraulic construction units for heating facilities which comprise at least a part of the internal flow paths of the heating facility and apart from a pump assembly, which is to say preferably a circulation pump assembly, comprise further hydraulic components, thus preferably the switching device according to the invention. The switching device is integrated with the pump assembly into a common construction unit which in particular also comprises the necessary flow paths between the switching device and the pump assembly. Furthermore, further components, such as for example sensors or a venting device can be integrated into this hydraulic block. The hydraulic block preferably comprises conduit connections which are provided for connection to further components of a heating facility. Thus preferably, a first conduit connection is provided for connection to a primary heat exchanger of the heating facility. Further preferably, a second conduit connection is provided for connection to a heating circuit through a building. Furthermore, a conduit connection for connecting to a secondary heat exchanger for service water heating can preferably be provided on the hydraulic block. Particularly preferably, the connection for connecting to the primary heat exchanger is connected in the inside of the hydraulic block to the delivery side of the pump assembly, whilst the connection for the secondary heat exchanger and the connection for the heating circuit are each connected to an inlet of the switching device in the inside of the hydraulic block. The switching device therein preferably forms a switch-over valve between a hydraulic circuit through the secondary heat exchanger and a hydraulic circuit through the heating circuit.

The invention is hereinafter described by way of example and by way of the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view showing a first example for a hydraulic system according to the invention, wherein the hydraulic system is in an idle condition;

FIG. 2 is a schematic view showing the hydraulic system according to FIG. 1, in a first switch position of the switching device;

FIG. 3 is a schematic view showing the hydraulic system according to FIGS. 1 and 2, in a second switch position of the switching device;

FIG. 4 is a schematic view showing the hydraulic system according to FIG. 3 in the second switch position in a further operation;

FIG. 5 is an exploded perspective view of a switching device for a hydraulic system according to the invention, and according to a first embodiment;

FIG. 6 is a sectional view of the switching device according to FIG. 5, in an idle condition;

FIG. 7 is a sectional view according to FIG. 6, in which the switching device is situated in a first switch position;

FIG. 8 is a sectional view according to FIGS. 6 and 7, wherein the switching device is situated in a second switch position;

FIG. 9 is a sectional view of a switching device according to a second embodiment of the invention;

FIG. 10 is a sectional view through the switching device as well as an adjacent pump assembly along the lines X-X in FIG. 9;

FIG. 11 is a sectional view of a switching device according to a third embodiment, wherein the switching device is situated in an idle position;

FIG. 12 is a sectional view according to FIG. 11, wherein the switching device is situated in a first switch position;

FIG. 13 is a sectional view according to FIGS. 11 and 12, wherein the switching device is situated in a second switch position;

FIG. 14 is a sectional view of a switching device according to a fourth embodiment, wherein the switching device is situated in an idle position;

FIG. 15 is a sectional view according to FIG. 14, wherein the switching device is situated in a second switch position;

FIG. 16 is a sectional view of a switching device according to a sixth embodiment, wherein the switching device is situated in an idle position;

FIG. 17 is a sectional view according to FIG. 16, wherein the switching device is situated in a second switch position;

FIG. 18 is a sectional view of a switching device according to a seventh embodiment, wherein the switching device is situated in a first switch position;

FIG. 19 is a sectional view according to FIG. 18, wherein the switching device is situated in a second switch position;

FIG. 20 is a lateral view of a hydraulic block with a switching device according to the invention;

FIG. 21 is a plan view of the hydraulic block according to FIG. 20;

FIG. 22 is a perspective view of the hydraulic block according to FIGS. 20 and 21 showing the switching device in an exploded perspective view;

FIG. 23 is a sectional view taken along the line A-A in FIG. 20 in one of three different switching positions of the switching device;

FIG. 24 is a sectional view taken along the line A-A in FIG. 20 in another of three different switching positions of the switching device; and

FIG. 25 is a sectional view taken along the line A-A in FIG. 20 in another of three different switching positions of the switching device.

### DESCRIPTION OF THE PREFERRED EMBODIMENTS

Referring to the drawings, the invention is hereinafter described by way of example and by way of a hydraulic system which represents a heating system. However, it is to be understood that the invention can also be applied in other hydraulic systems, in particular in hydraulic systems, in which a switching between two flow paths is necessary. This particularly applies to a circulation system but is expressly not limited to such.

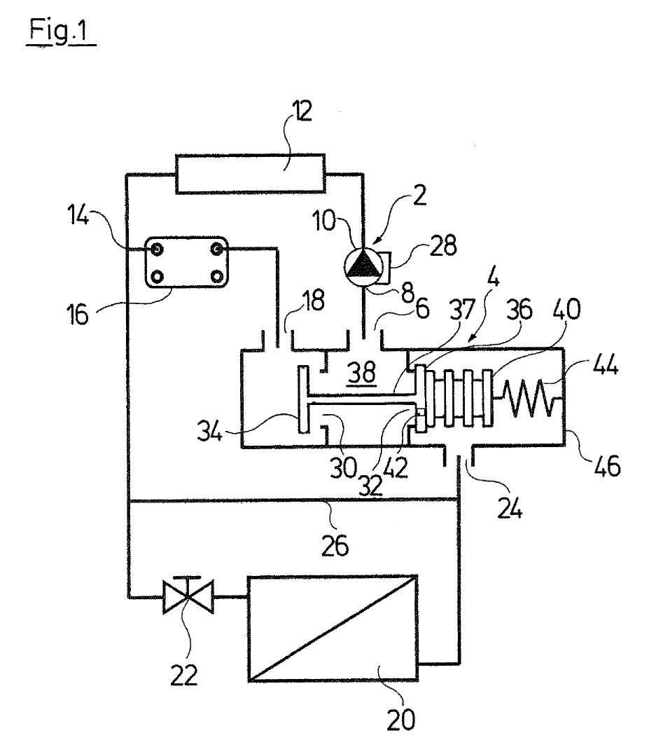

FIG. 1 shows an embodiment example of a hydraulic system according to the invention, as is applied in a heating installation, in particular compact heating installation. The hydraulic system as essential components comprises a pump assembly 2 configured as a circulation pump assembly, as well as a switching device 4 acting as a switch-over valve. The exit 6 of the switching device 4 in this example is hydraulically connected to the suction-side connection 8 of the pump assembly 2. The switching device 4 in this embodiment example thus lies at the suction side of the pump assembly 2, and this means that the pressure difference between the delivery-side connection 10 or the exit side 10 of the pump assembly 2 and the switching device 4 is larger than between the switching device 4 and the suction-side connection 8. A primary heat exchanger 12 at the exit side connects to the pump assembly 2 in the flow path in this embodiment example. The primary heat exchanger 12 for example is the heat exchanger in a heating boiler, in which the heating water is heated by way of a gas burner, oil burner or pellet burner. The heating water however can be heated in another manner in the primary heat exchanger 12, for example by way of a solar installation, heat pump or likewise. Moreover, it is to be understood that the system in a corresponding manner could also operate as a cooling system, wherein the primary heat exchanger 12 would not serve for heating, but for cooling.

A branching point or node point 14, at which the flow path branches, connects downstream of the primary heat exchanger 12. A first branch of the hydraulic system, departing from the node point 14, runs through a secondary heat exchanger 16, in which for example service water to be heated is heated. This branch of the hydraulic circuit, at the exit side of the secondary heat exchanger 16, runs out into a first entry 18 of the switching device 4. A second branch which extends in a manner departing from the node point 14 forms a heating circuit which for example serves for heating a building. This heating circuit here is represented schematically by a radiator 20 with a regulation valve 22 which is arranged on this. The regulation (control) valve 22 can for example be a common thermostat valve. This heating circuit at the exit side runs out into a second entry 24 of the switching device 4. It is to be understood that indeed such a heating circuit can comprise more than one radiator 20 which are connected in parallel and/or in series. In this example, the heating circuit yet comprises a bypass 26 which serves for permitting a flow through the heating circuit when the regulation valve 22 or all regulation valves 22 in the heating circuit are closed.

What is essential to the invention is the special design of the switching device 4 which is configured such that one can make do without a separate drive for the switching device 4 and in contrast this can be switched over solely via the circulation pump 2 by way of changing the operating condition of the pump assembly 2. This is effected by a control device 28 of the pump assembly 2. In this example, the control device 28 is integrated directly into the pump assembly 2, for example directly on or in the motor casing of the pump assembly 2. With regard to the pump assembly 2, it is preferably the case of a circulation pump assembly which can be closed-loop controlled in its speed and is activated via a frequency converter. This in particular is configured as a centrifugal pump assembly, preferably with a wet-running electric motor.

The switching device 4 serves for switching between the two described flow paths, which is to say on the one hand through the secondary heat exchanger 16 and on the other hand through the radiators 20 of the heating circuit. For this, the switching device comprises two valve seats 30 and 32, to which in each case a valve element 34 and 36 respectively (switching element 34 and 36) is assigned. The valve elements 34, 36 are connected to one another in a fixed manner and are arranged such that they can be alternately brought into sealing contact with the respective associated valve seat 30, 32. This means that when the valve element 36 sealingly bears on the valve seat 32, as in the condition represented in FIG. 1, the valve element 34 is distanced to its valve seat 30, so that the flow path through the valve seat 30 is opened. The valve seats 30, 32 run out into a connection space 38 which is hydraulically connected to the exit 6. In this example, the valve seats 30, 32 are away from one another and from the connection space 38. The valve element 34 faces the connection 18, so that it is subjected to onflow from the first entry 18 and is subjected to pressure. The valve element 36 faces the second entry 24 and is thus subjected to onflow through the second entry 24 and is subjected to pressure. This arrangement of the valve elements 34, 36 has the effect that the pressure prevailing at the entries 18 and 24 acts upon the valve elements 34, 36 such that these are pressed in each case against their associated valve seat 30, 32. A self-holding function of the switching device 4, as is described hereinafter is achieved by way of this.

Moreover, an elastic bellows 40 whose closed interior is in connection with the connection space 38 via a through-hole 42 in the valve element 36, is arranged on the valve element 36, away from the valve seat 32. The through-hole 42 is configured as a throttle location. A spring 44 which is configured as a tension spring engages on the end of the bellows 40 which is away from the valve element 36, and the spring at its other end is fastened on the housing 46 of the switching device 4.

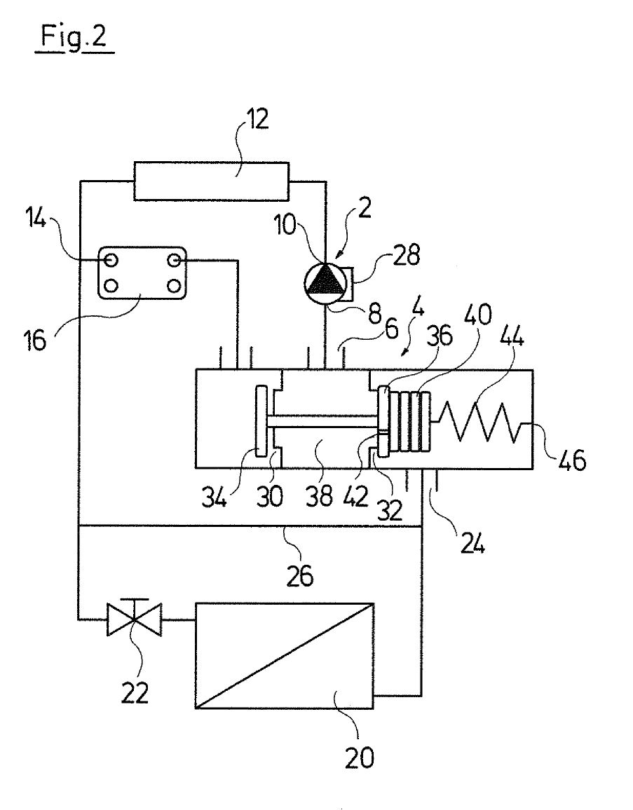

FIG. 1 shows the first switch position of the switching device 4 or the switching elements (valve elements 34 and 36). In this switch position, the valve seat 32 is closed by the valve element 36 and the flow path through the heating circuit is thus closed. If the pump assembly 2 delivers, it thus delivers liquid, which is to say water in particular, in the circuit through the primary heat exchanger 12 and the secondary heat exchanger 16. The pressure is transmitted from the node point 14 through the closed circuit 20 and, as the case may be, through the bypass 26 to the second entry 24 of the switching device 4, due to the fact that the valve is closed on the valve seat 32. There, at the second entry, this pressure acts upon the face side of the bellows 40. The pressure prevailing in the connection space 38 simultaneously acts in the inside of the bellows via the through-hole 32. This pressure essentially corresponds to the pressure at the suction-side connection 8 of the pump assembly 2. Thus a pressure difference exists at the face side of the bellows 40 and this with the operation of the pump assembly 2 in this condition leads to the bellows 40 being compressed and the tension spring 44 being lengthened, as is shown in FIG. 2. This is the condition which serves for heating the service water and in which the heating medium is delivered through the secondary heat exchanger 16. This condition is automatically held as long as the pressure prevailing at the second entry 24 is greater than the force of the spring 44. This is the case as long as the pump assembly 2 is situated in a first operating condition, in which the speed lies above a predefined limit speed. The predefined limit speed is stored in the control device 28 and is set such that the pressure at the second entry 24 is so high that the force which acts upon the bellows 40 and the valve element 36 and which is produced by this pressure is larger than the tension force which is exerted by the spring 44.

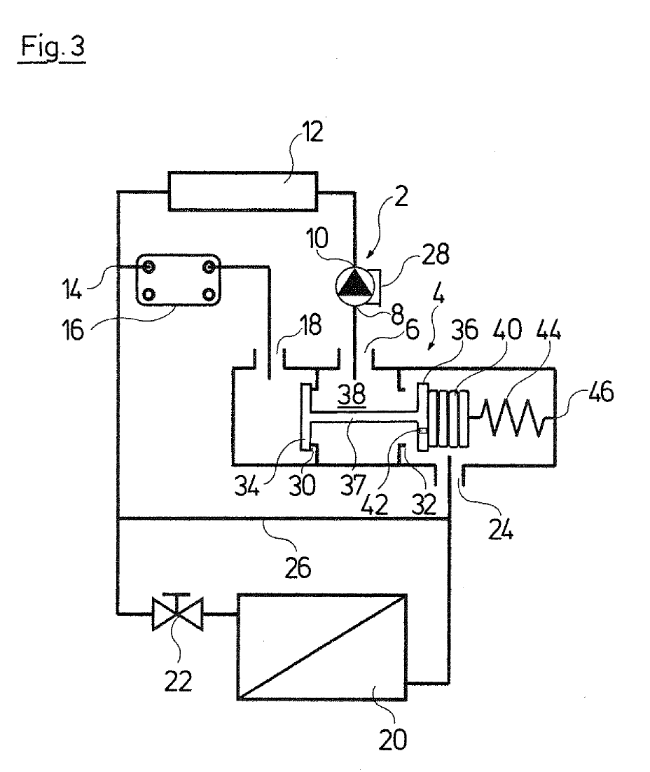

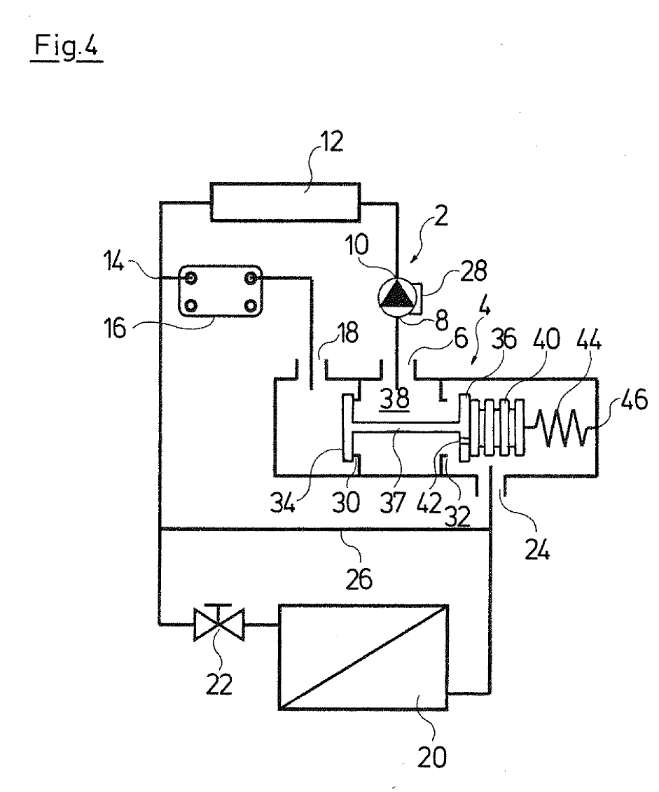

The pump assembly 2 is brought into a second operating condition by way of the control device 28, in which second operating condition the speed lies below the predefined limit speed, in order to move the valve or the switching device 4 into its second switch position, in which the valve seat 30 is closed and the second valve seat 32 is opened. In this condition, the pressure at the second entry 24 drops to such an extent that the force which is directed by the pressure on the bellows 40 toward the valve seat 32 is smaller than the tension force exerted by the spring 44. This leads to the spring 44 contracting as is shown in FIG. 3, and lifting the bellows 40 with the valve element 36 fastened thereon, from the valve seat 32. Thereby, the valve element 34 is simultaneously brought into sealing contact on the valve seat 30 due to the coupling of the valve elements 36 and 34. This means that the valve elements 36 and 34 are moved to and fro between the first and the second switch position. The bellows 40 does not relax in a direct manner with this movement, since its interior can only be filled via the through-hole 42 acting as a throttle. The bellows 40 is thus firstly co-moved in the essentially pressed-together condition. Only later does the bellows 40 slowly unfold again into a condition, as is shown in FIG. 4. If the pump assembly 2 is again brought into the first operating condition by way of its control device 28 before this unfolding of the bellows 40, the speed of the pump assembly 2 increases again and with this again the pressure at the node point 14, said pressure is now transmitted via the secondary heat exchanger 16 to the first entry 18 and thus onto the surface of the valve element 34. A force holding the valve element 34 in a closed condition pressed against the valve seat 30 thus acts upon the valve element 34. A stable condition is again achieved. The switching device 4 is thus configured in such a bistable manner that it is automatically held in each of the two described switch positions on operation of the pump assembly 2 with an adequately high speed. An external drive or an external holding force is not necessary for this.

As described, the selection of the new switch position depends on the point in time, at which the pump assembly 2 is brought again into the first operating condition, which is to say that the selection of the switch position depends on how long the pump assembly 2 is operated in the second operating condition. If the pump assembly 2 is not switched again into the first operating condition 1 at the correct time, then the switching device 4 switches back into the first switch position by way of the return displacement of the valve elements 34 and 36. The switching device 4 is again operated in the first switch position, when the pump assembly 2 is again brought into the first operating condition.

Moreover, the described switching-over is likewise effected without an external drive, but solely via a hydraulic coupling of the pump assembly 2 to the switching device 4 via the hydraulic system itself. The spring 44 serves as an energy store which receives energy on operating in the first operating condition and then releases it again due to relaxation on switching into the second operating condition. Thus a force for moving the valve element is produced by the spring 44. The energy or switching energy which is required for this is previously taken by the spring 44 from the hydraulic system in the first operating condition.

The bellows 40 with the through-hole 42 which acts as a throttle serves for decoupling the spring 44 from the valve elements 34 and 36 during the charging procedure, with which the spring 44 absorbs energy. The bellows 40 thus specifically permits the spring 44 to be extended in a first operating condition, without having to move the valve elements 34 and 36. The valve elements 34 and 36 in contrast remain in the starting position shown in FIGS. 1 and 2. However, on switching into the second operating condition with a lower speed, a direct coupling between the spring 44 and the valve element 36 essentially exists due to the throttle location which is formed by the through-hole 42, so that the valve element 36 is moved directly by the spring 44. What is essential is the fact that the control device 28 switches the pump assembly 2 from the second operating condition 2 in an adequately rapid manner back into the first operating condition 1, before the bellows 40 can completely unfold, so that the switching device or the valve element 34 is held in the second switch position which is shown in FIG. 4, again by way of the hydraulic pressure. If the pump assembly is switched off in this second switch position, the hydraulic pressure acting upon the valve element 34 then falls away, so that a pressure force against the bellows 40 no longer acts upon the valve element 34 and the valve element 36. The effect of this is that the bellows 40 can then unfold further into the condition which is shown in FIG. 1, on account of its elasticity. If the spring 44 is completely compressed in this condition, then the bellows 40, which then acts as a spring, presses the valve elements 34 and 36 back again into their initial position, which is to say the first switch position which is shown in FIG. 1. The system can be taken into operation again from this first switch position, by way of starting operation of the pump assembly 2. A further compression spring could be additionally provided in the inside or outside the bellows 40 as a restoring element, additionally to the elasticity of the spring bellows 40.

What is essential to the system is the fact that the two operating conditions merely necessitate different speeds and thus different starting pressures of the circulation pump assembly 2, but not a rotation direction reversal of the pump assembly 2. This benefits the efficiency. Moreover, it is not necessary to completely switch off the pump assembly 2 for switching the two operating conditions However, it is also possible for the second operating condition to not only have a reduced speed, but for the pump assembly 2 to be completely stopped in the second operating condition. Even then, it only needs to be started in operation again sufficiently rapidly, in order to prevent a return movement of the valve elements 34 due to the expansion of the bellows 40 or, as the case may be, an additional spring. This means that the selection of the switch position is dependent on how long the pump assembly 2 is operated in the second operating condition.

The switching device 4 which is described here, as also the subsequently described embodiment examples of switching devices are envisaged to be arranged at the suction side of the pump assembly 2 in the described manner. However, it is to be understood that a suitably configured switching device can also be applied at the delivery side of the pump assembly 2. With the switching device represented in FIGS. 1 to 4, the valve elements 34 and 36 would then merely need to be arranged not on valve seats 30, 32 which are away from one another, but on valve seats which face one another, which is to say in the inside of the connection space 38, in order to achieve the desired self-holding function, as has been described.

Different embodiment examples of switching devices are now described hereinafter, and these can all be integrated in to a hydraulic system such as the shown heating system, in the manner described by way of FIGS. 1 to 4. The remaining components which are not shown in the following examples, in particular the pump assembly 2 as well as the heat exchanger 12, 16 and 20, and their arrangement can correspond to this. The previous description is referred to inasmuch as this is concerned.

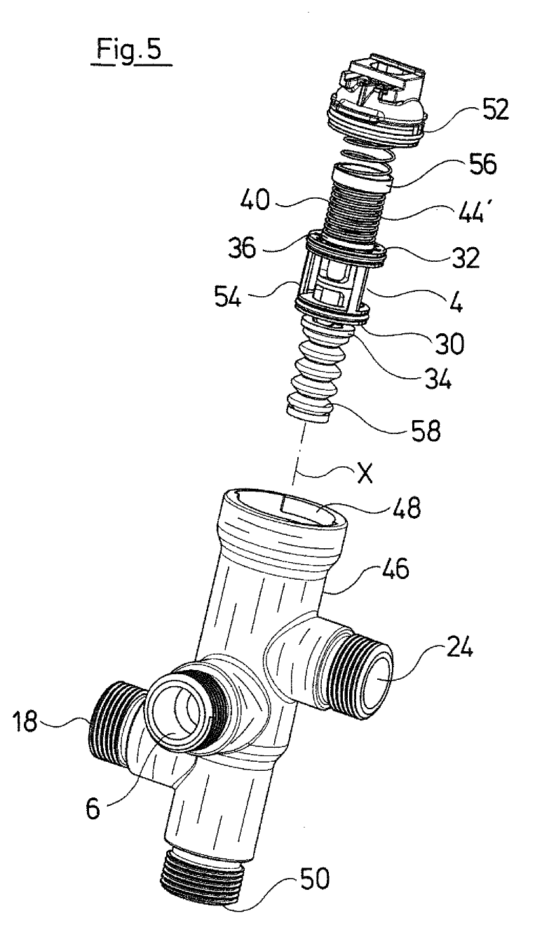

The subsequently described embodiment examples according to FIGS. 5 to 8 as well as 11 to 19 differ in the manner of the construction of the switching device. Common to these switching devices is a housing 46, in which the actual switching device 4 is arranged as a cartridge. This permits a simple assembly also in complex conduit systems, as for example exist with integrated construction units for compact heating installations, so-called heating blocks. The housing 46 comprises an insert opening 48 at a longitudinal end, as well as a further assembly opening 50 at the opposite longitudinal end. The insert opening 48 is closed by a closure 52, and the assembly opening 50 is closed by a threaded plug which is not represented here, for operation. The exit 6 as well as the first entry 18 and the second entry 24 are formed on the housing as connection pieces (branches). Single-piece connections or connections formed in a different manner, to further components of the hydraulic system can also be provided instead of this connection piece, in particular if the housing 46 is part of an integrated construction unit for a heating installation. As also in the embodiment example according to FIGS. 1 to 4, the entries 18 and 24 as well as the exit 6 are offset in the axial direction X, wherein the exit 6 lies between the entries 18 and 24.

The switching device 4 which is represented in FIGS. 5 to 8 functions in a manner as was described by way of FIGS. 1 to 4. A connection space 38 is provided in the inside of the housing 46 in a manner adjacent to the exit 6, and this connection space comprises two valve seats 30 and 32 which are away from one another. As is to be recognized in FIG. 5, the valve seats 30 and 32 are formed on a central carrier element 54 which is sealingly inserted into the receiving space 38. A first valve element 34 faces the valve seat 30, and a second valve element 36 faces the valve seat 32. The valve elements 34 and 36 are the switching elements of the switching device and are connected to one another via a connection element 37. In the example shown here, the connection element 37 is formed by extensions of the valve elements 34 and 36 which are screwed to one another. A different type of connection or a single-piece construction of the valve elements 34 and 36 is also possible.

A bellows 40 bears on the valve element 34, as is described by way of FIGS. 1 to 4. This bellows at its axial end which is away from the valve element 36 is closed by a disc 56 serving as a pressure surface. The pressure prevailing at the second entry 24 acts upon the disc 56, as was described beforehand, and thus produces a pressing force which is directed in the axial direction X toward the valve seat 32. A spring 44′ is arranged surrounding the bellows 40 and is supported with a first axial end on the valve element 36 and on the opposite axial end in the closure 52 and is thus fixed on the housing 46. The disc 56 is fastened in the spring 44′, so that it divides the spring into two sections, a first section which is situated between the disc 56 and the closure 52, and a second section which is situated between the disc 56 and the valve element 36. The first section of the spring 44′ thereby has the function of the spring 44 which has been described by way of FIGS. 1 to 4, and as a whole the spring 44′ in the two sections acts as a tension spring as well as a compression spring, as is described hereinafter.

A through-hole 42′ is formed in the connection element 37 and this, as is the case with the through-hole 42, acts as a throttle and connects the interior of the bellows 40 to the interior of the second bellows 58, said second bellows being arranged on the valve element 34 at its side which is away from the valve seat 30. Thus a closed system which can be filled with a fluid, in particular water, is therefore created in the inside of the bellows 40 and 58. No fluid exchange thereby occurs with the surrounding fluid in the hydraulic system, so that a contamination of the throttle location formed by the through-hole 42 can be prevented.

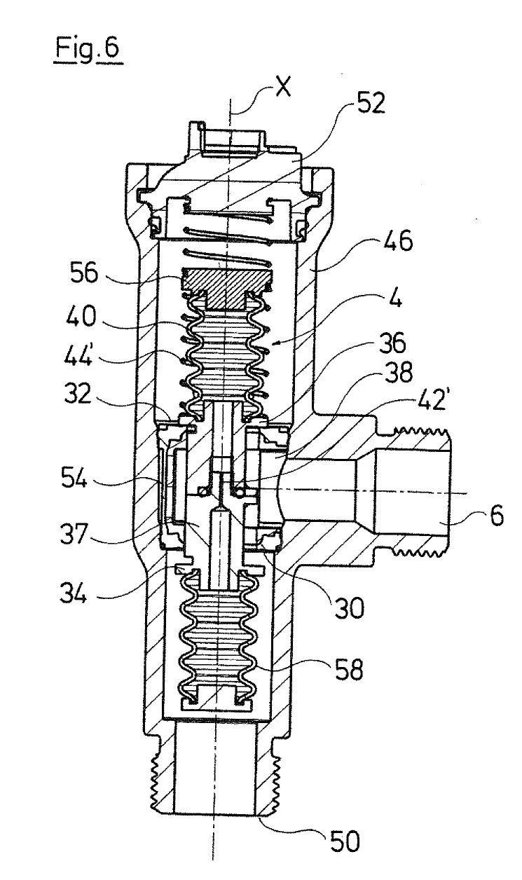

FIG. 6 shows the idle position of the switching device 4, in which the switching device or its valve element 34 and 36 are situated in their first switch position, in which the valve element 36 bears on the valve seat 32 and the valve element 34 is distanced to the valve seat 30. Thus according to the representation in FIG. 1, a first flow path, in particular through a secondary heat exchanger 16 is opened, when the switching device is applied in a corresponding manner as shown in FIGS. 1-4. The spring 44′ in this position in its entirety acts as a compression spring and presses the valve element 36 against the valve seat 32. If in this condition, the pump assembly 2 is set into operation in its first operating condition with a speed above its first limit speed, then a pressure producing a pressure force on the disc 56 in the longitudinal axis X to the valve seat 32 is produced at the second entry 24 in the manner described above. Thereby, the disc 56 is moved against the pressing force of the second section of the spring 44′ since a lower pressure prevails at the first entry 18, wherein the bellows 40 is compressed. The fluid in the inside of the bellows 40 is thereby brought through the through-hole 42′ into the inside of the second bellows 58. The first section of the spring 44′ is simultaneously lengthened by way of the movement of the disc 56 away from the closure 52, so that this section is stretched as a tension spring. Energy or switching energy is stored in the spring in this operational condition in this manner.

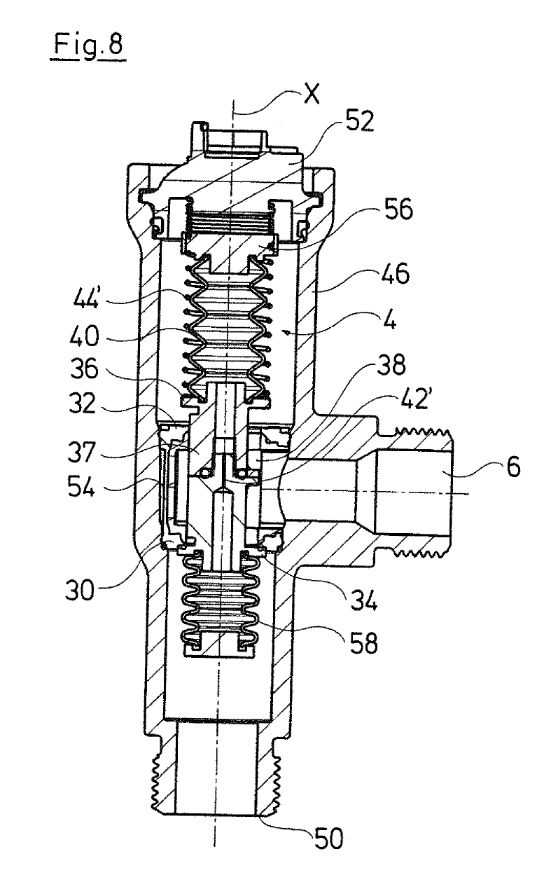

If the pump assembly 2 is now switched by its control device 28 into the second operating condition with a lower speed, then the pressure acting upon the disc 56 reduces so that the force acting upon the disc 56 in the axial direction X is no longer in equilibrium with the spring force of the extended first section of the spring 44′. This first section of the spring thus pulls the disc 56 away from the valve seat 32. Since the bellows 40 is not filled again straightaway due to the throttle effect of the through-hole 42, the compressed bellows thereby together with the valve element 36 is moved away from the valve seat 32 and the valve is thus opened. The valve element 34 simultaneously comes into sealed contact on the valve seat 30. If the pump assembly 2 is now set into the first operational condition with a higher speed before the bellows 40 unfolds again, the greater pressure then acts at the first closure 18 and thus produces a force which acts towards the valve seat 30 in the axial direction X, upon the face side of the bellows 58 and thus upon the valve element 34. This force holds the valve element 34 with a sealed contact on the valve seat 30. Thus, a self-holding condition of the valve is achieved on operation of the hydraulic system. The second bellows 58 now empties via the through-hole 42′ due to the pressure force, so that the first bellows 40 is expanded again and reaches the condition which is represented in FIG. 8. In this condition, the first section of the spring 44′ which previously acted as a tension spring is compressed, so that this section now acts as a compression spring. If the pump assembly is switched off out of this condition, then the pressure upon the face side of the second bellows 58 falls away and the first section of the spring 44′ between the disc 56 and the closure 52 acts as a restoring element and produces such a pressing force, that the bellows 40 together with the valve element 36 is moved again against the valve seat 32, so that the starting position shown in FIG. 6 is reached. Again fluid is simultaneously relocated out of the bellow 40 into the bellows 58, since the second section of the spring 44′ likewise relaxes which is to say contracts. If with this embodiment, the pump assembly 2 is not brought out of the second operating condition into the first operating condition rapidly enough, then a switch-over into the second switch position does not occur, since the valve elements 34 and 36, with their to and fro movement, move back again into the first switch position when the bellows 40 relaxes.

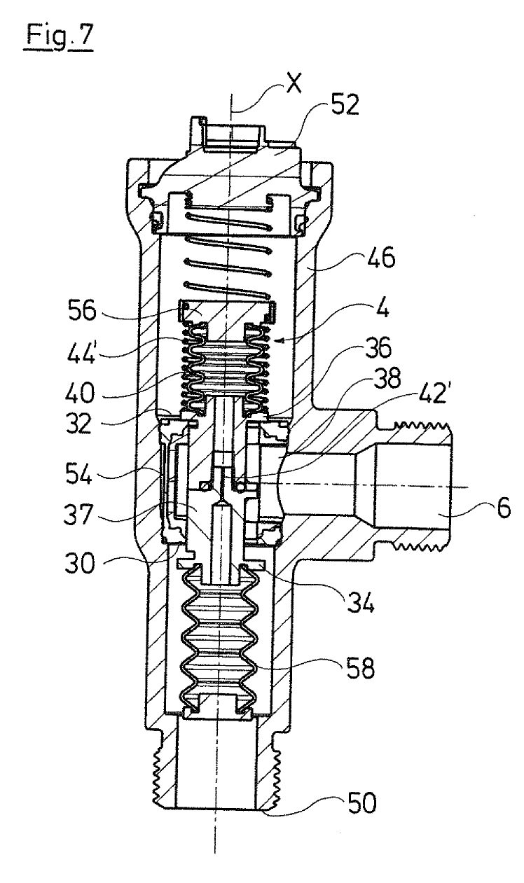

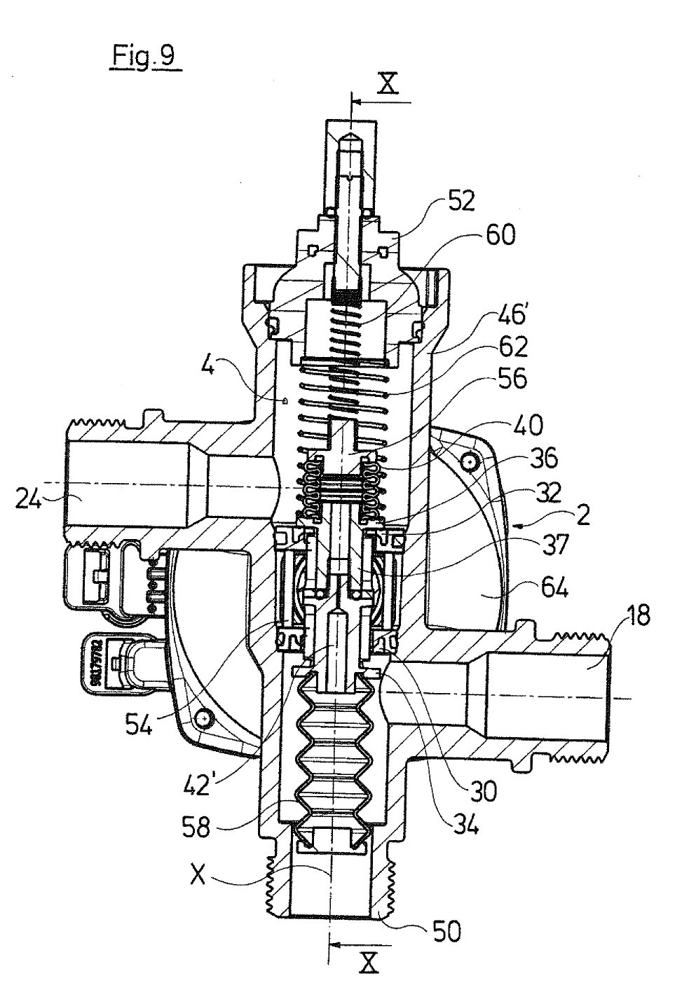

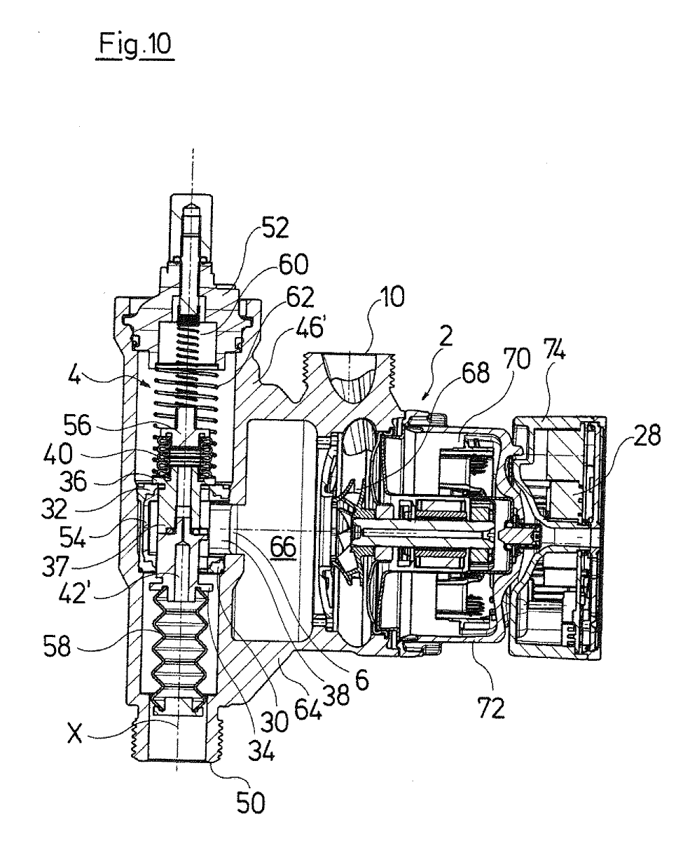

The embodiment example in FIGS. 9 and 10 shows a further embodiment of the switching device according to the invention, and this corresponds essentially to the switching device which is explained by way of FIGS. 5 to 8. Only the arrangement of the springs is different. With the embodiment example according to FIGS. 9 and 10, two springs 60 and 62 are provided instead of one spring 44′, and specifically a tension spring 60 and a compression spring 62. The compression spring 62 is supported directly between the closure 52 and the valve element 36, whereas the tension spring 60 connects the disc 56 to the closure 52. The FIGS. 9 and 10 show the first switch position which corresponds to FIG. 7, which is to say during which the pump assembly is situated in the first operating condition and the bellows 40 is compressed by the pressure at the second entry 24. The spring 60 acts as a tension spring which, when the bellows 40 is compressed, is extended and functions as energy store. If the pump assembly 2 is switched into the second operating condition with a reduced speed and the holding force which acts upon the valve element 36 dwindles, then the tension spring 60 pulls the arrangement consisting of the disc 56, the compressed bellows 40 and the valve element 36, in the direction of the closure 52, which is to say away from the valve seat 32 in the axial direction X. Thereby, the valve element 34 is simultaneously brought to bear on the valve seat 30. The compression spring 62 which functions as a restoring element, is simultaneously compressed with this movement. On switching off the pump, the compression spring 62 moves the valve element 36 again into the starting position, in which the valve element 36 bears on the valve seat 32. The tension spring 60 must muster a greater force than the compression spring 62, since the tension spring 60 must overcome the spring force produced by the compression spring 62, in order to switch over the valve in the described manner.

In contrast to the embodiment described by way of FIGS. 5 to 8, with the embodiment example according to FIGS. 9 and 10, the housing 46′ of the switching device 4 is configured in an integral manner with the pump casing 64 of the pump assembly 2. Here, the pump casing 64 and the housing 46′ are configured in a single-piece manner. The exit 6 of the switching device 4 runs out directly into the suction chamber 66 of the pump casing. An impeller 68 which is driven via an electric drive motor 70 configured as a canned motor is arranged in the pump casing. The drive motor 70 is arranged in a motor or stator casing 72 which is connected to the pump casing 64. A terminal box or electronics housing 74, in which the control device 28 is arranged, is applied onto the motor casing 72 at the axial side. A construction unit consisting of the pump assembly, the control device 28 and the switching device 4 is thus created, and this as such can be integrated into a hydraulic system in a simple manner. It is to be understood that the previously described and subsequently described examples of switching devices can be integrated with the pump assembly 2 into a construction unit in the same manner, as is represented in FIGS. 9 and 10. The further embodiment examples are described by way of a separate housing 46 for simplification.

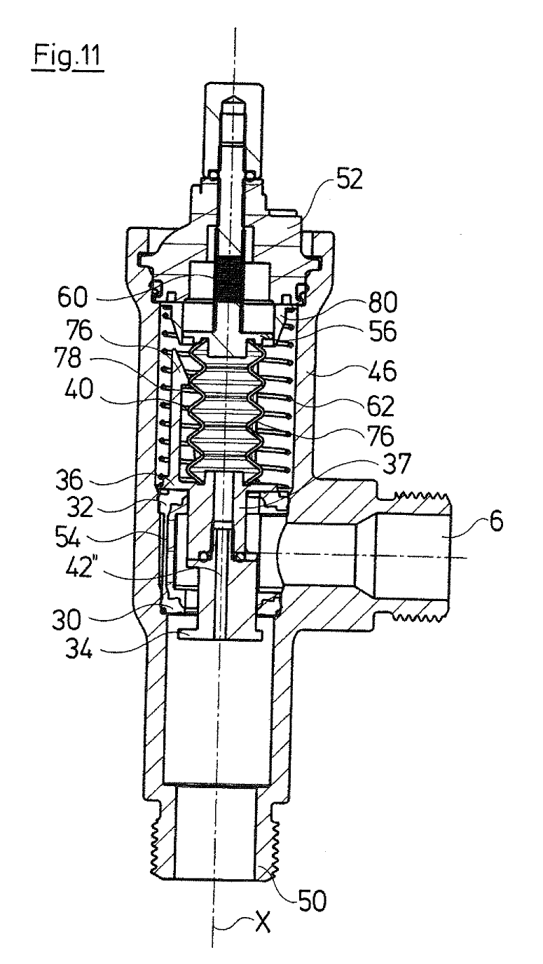

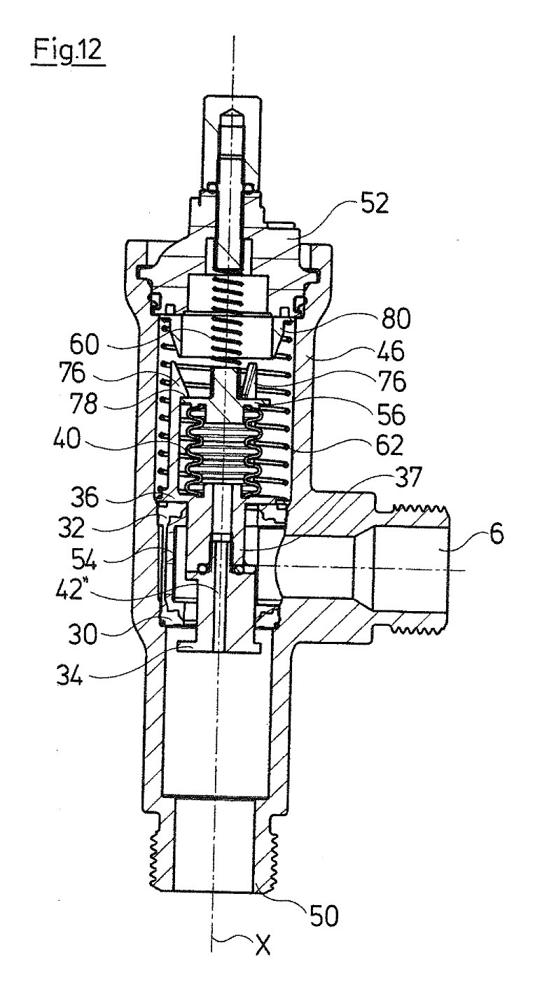

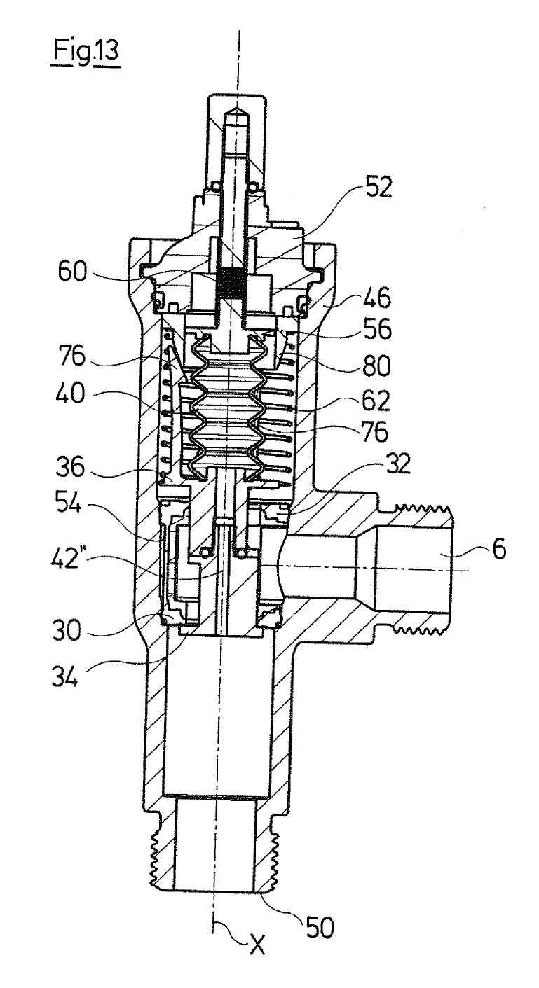

The embodiment which is shown in FIGS. 11 to 13 differs from the preceding embodiments in that the decoupling of the charging procedure from the movement of the valve element 36 and the coupling of the movement of the valve element 36 to the charging procedure of the energy store is not effected via a through-hole 42, 42′ which acts as a throttle location, but via a mechanical locking as is described hereinafter. The through-hole 42″ which is represented in FIGS. 11 and 13 between the valve elements 34 and 36 essentially does not act as a throttle location. As with the embodiment according to FIGS. 9 and 10, a tension spring 60 which is fastened on the closure 52 engages on the disc 56 closing the bellows 40 at the axial end. A compression spring 62 is also provided with this embodiment, and this spring with one axial end is supported on the closure 52 and with the opposite axial end bears on the valve element 36. The compression spring 62 in the starting or idle position which is shown in FIG. 11 presses the valve element 36 against the valve seat 32, so that the valve element 34 is simultaneously lifted from the valve element 30. The tension spring 60 is completely contracted in this condition. If now the pump assembly 2 is switched on in this condition by the control device 28 and is operated at a high speed in the first operating condition, then a pressure force which displaces the disc 56 in the axial direction X towards the valve seat 32 acts upon the disc 56 in the previously described manner due to the hydraulic pressure which prevails at the second entry 24. The bellows 40 is thereby compressed and the fluid in the inside of the bellows 40 is pressed through the through-hole 32′ through the valve element 34 into the surrounding hydraulic system. This means that no closed system is envisaged inside the bellows 40. The disc 56 thereby passes detent (locking) hooks 76 which, departing from the valve element 36 extend parallel to the axial direction X. The detent hooks 76 are configured as resilient tongues and are fixedly connected to the valve element 36, preferably configured as one piece with this. The detent hooks 76 in each case are bevelled at their free end facing the closure 52, such that they radially widen on passing the disc 56. They spring back radially inwards after passing the disk 56 and hold the disc 56 on the contact shoulders 78.

If now the pump assembly is switched into the second operating condition with a lower speed, then the pressure force upon the disc 56 reduces, so that the spring force which is produced by the tensioned tension spring 60 exceeds this pressure force. The switching energy which is stored in the tension spring 60 thus discharges and the tension spring 60 pulls the disc 56 towards the closure 52 in the axial direction. Thereby, since the disc 56 bears on the contact shoulders 78 of the detent hooks 76, the valve element 36 connected to the detent hooks 76 is co-moved and is lifted from the valve seat 32 in the axial direction X. The other valve element 34 is co-moved via the connection element 37 and is brought to bear on the valve seat 30 as is shown in FIG. 13. A ring element 80 which is conical at the outer periphery, is arranged on the closure 52 and departing from this extends in the axial direction enters between the detent hooks 76 when the valve element 36 is moved in the axial direction by a certain amount. The ring element 80 thus enters between the detent hooks 76 since these are pressed radially outwards, so that the contact shoulders 78 disengage from the disc 56. In this condition, the tension spring 60, as the case may be, assisted by elastic restoring forces of the bellows 40, can move the disc 56 further towards the closure 52 and thus relax the bellows 40, wherein the inside of the bellows 40 is filled with fluid from the hydraulic system again via the through-hole 42′. The pump assembly 2 is set back into the first operating condition in good time, before the disc 56 is released from the detent hooks 76 in the described manner, in order to again obtain a stable operating condition, in which the valve formed by the valve seat 30 and the valve element 34 is held in a closed manner. Again, in this first operating condition, such a high pressure is now produced at the first entry 18, that a pressing force which presses the valve element 34 onto the valve seat 30 against the pressing force produced by the compression spring 62 is produced by the pressure upon the valve element 34. If the pump assembly is switched off or is switched back into the second operating condition, then the pressing force which acts upon the valve element 34 reduces to such an extent, that the pressing force which is produced by the compression spring 62 becomes larger, so that the valve element 36 and the valve element 34 are then moved back again into the starting position which is shown in FIG. 11. If the pump assembly 2 is not switched back again into the first operating condition within a predefined time duration, then the detent connection between the disc 56 and the detent hooks 76 is released and the compression spring 62 presses the valve element 36 and the valve element 34 back again into the first switch position. This means that with the to and fro movement of the valve elements 34 and 36, it is a question of the correct switch-on point in time for switching on the first operating condition, in order to hold the valve elements 34 and 36 in the second switch position.

With the embodiment example according to FIGS. 11 to 13, in contrast to the preceding embodiment examples, a delay of the relaxing of the bellows 40 is not realized via a throttle location but via the covered path distance and the mechanical blockage which is formed by the detent hooks 75. However, with this embodiment too, one also succeeds in the spring 60 being able to absorb energy from the hydraulic system in a charging procedure, without having to significantly displace the valve elements 34 and 36. This absorbed energy can then be released again in a second operating condition of the pump assembly for displacing the valve elements 34 and 36.

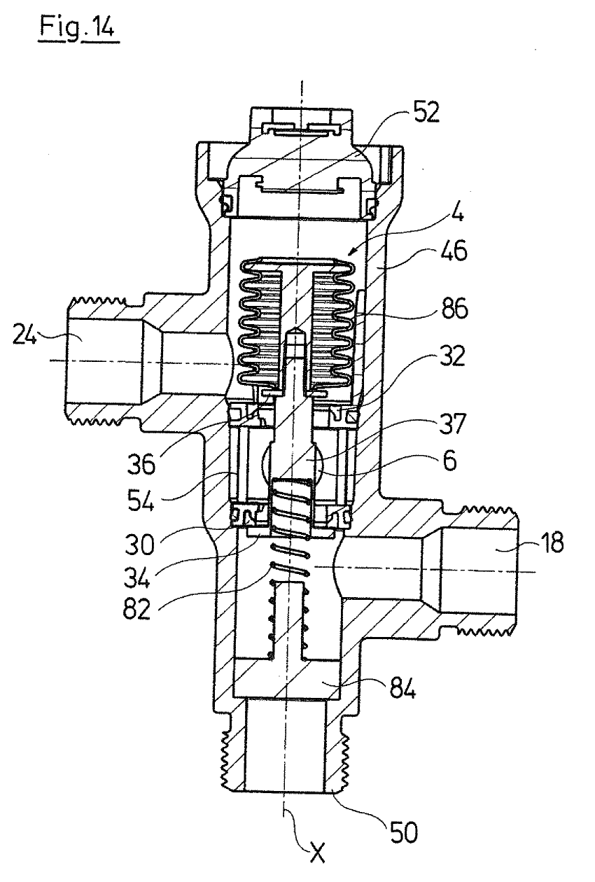

The subsequently described embodiment examples according to FIGS. 14 to 19 differ from the previously described embodiment example by way of not providing a separate energy store, in particular no energy store in the form of a spring, in the switching device 4, but this switching device utilizing energy which is stored in the hydraulic system itself, in particular in the form of inertia energy of the circulating fluid.

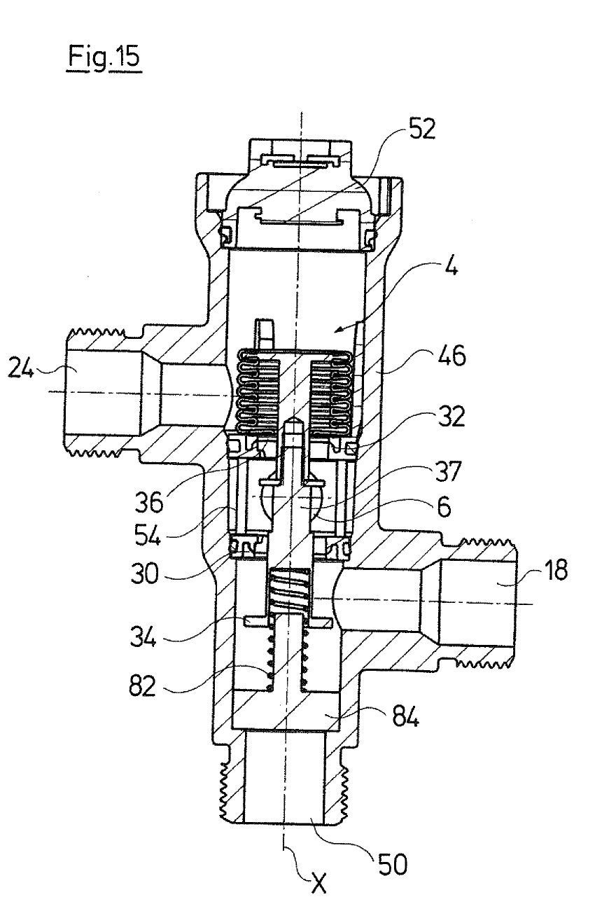

FIGS. 14 and 15 show a first embodiment example of a switching device 4 for such a system. FIG. 14 shows the starting position with a first switch position of the valve elements 34 and 36 which are connected to one another via the connection element 37. In this embodiment example too, the valve elements 34 and 36 can also alternately come to bear on the valve seats 30 and 32 which are configured and arranged essentially as described beforehand. The design of the housing 46 with the connection or the entries 18 and 24 as well as the exit 6 also corresponds to the previously described fashioning. The preceding embodiments are referred to inasmuch as this is concerned. With this embodiment example, the valve which is formed by the valve seat 30 and the valve element 34 is closed, as is shown in FIG. 14, in the starting or idle position which corresponds to the first switch position. The idle position is held by a restoring spring 82. The restoring spring 82 is configured as a compression spring and is supported between the valve element 34 and a carrier 84 which bears on the assembly opening 50. The carrier 84 could also be configured as one piece with the housing 46. When the pump assembly 2 is set into operation in this condition, and one operates in the first operating condition with a high pressure, then the pressure at the node point 14 prevails at the entry 18 and presses against the valve element 34, so that this is held in contact on the valve seat 30. Thus, a stable, self-holding condition is given on operation of the hydraulic system. Fluid simultaneously flows from the second entry 34 through the gap between the valve element 36 and the valve seat 32 to the exit 6. Thereby, the fluid or the flowing liquid has certain kinetic energy. If now the pump assembly 2 is switched into a second operating condition with a lower speed which lies below a limit speed, down to which the self-holding function is given, the force acting upon the valve element 34 by the pressure reduces so that the self-holding function is lifted. Thereby, the pressure reduces more rapidly than the flow speed or the kinetic energy of the fluid which originates from the flow. This flow energy continues to act upon the valve element 36, so that this is then entrained by the flow and is brought into contact with the valve seat 32, whilst the valve element 34 is simultaneously lifted from the valve seat 30 via the connection element 37. This means that a to and fro movement of the valve elements 34 and 36 takes place.

Again, a self-holding condition is achieved, which continues to be held when the pump assembly is then again brought into its first operating condition. If this is not effected, then the arrangement of the two valve elements 34 and 36 can move again back into the first switch position, in particular also due to the effect of the spring 82. This means that here too, it is a question of when the pump assembly 2 is switched again into the first operating condition. Thus a switch-over of the flow path between the entries 18 and 24 is hereby also possible without an additional drive, wherein energy which was previously stored in the system is utilized for moving the valve elements 34 and 36. A bellows (bag) 86 which connects the valve element 36 to the connection element 37 is additionally provided in this system. The bellows 86 serves as a damper and prevents the valve element 36 from moving back again straight away due to the impact energy, when it is pressed against the valve seat 32 by the flow. This impact energy can be absorbed by way of the bellows 86 springing in. I.e., the valve element 34 and the connection element 37 can move yet further, whilst the valve element 36 already closes the valve seat 32. This condition is shown in FIG. 15. If the pump assembly is switched off in this condition, then the hydraulic pressure exerting the holding force upon the valve element 36 is again lifted, so that this holding force is overcome by the pressing force which the spring 82 exerts. The spring 82 then as a restoring element moves the valve elements 34 and 36 again into the starting position represented in FIG. 14.

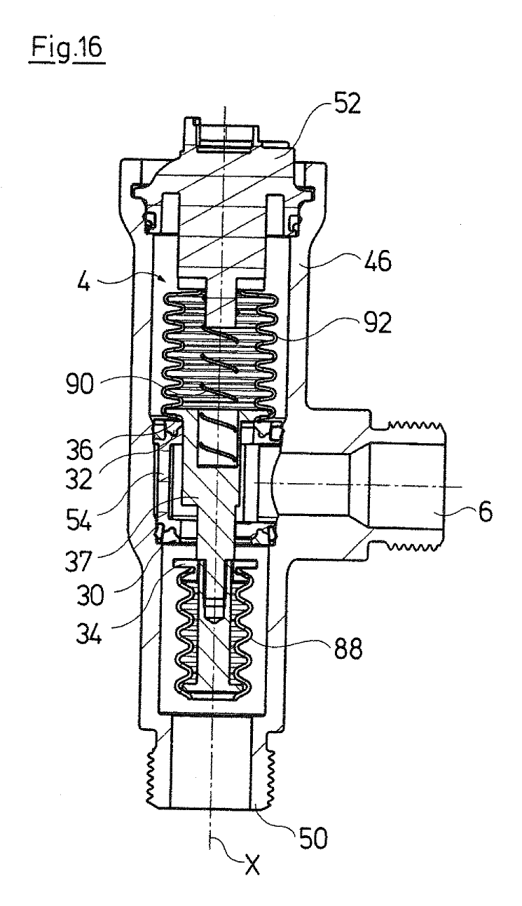

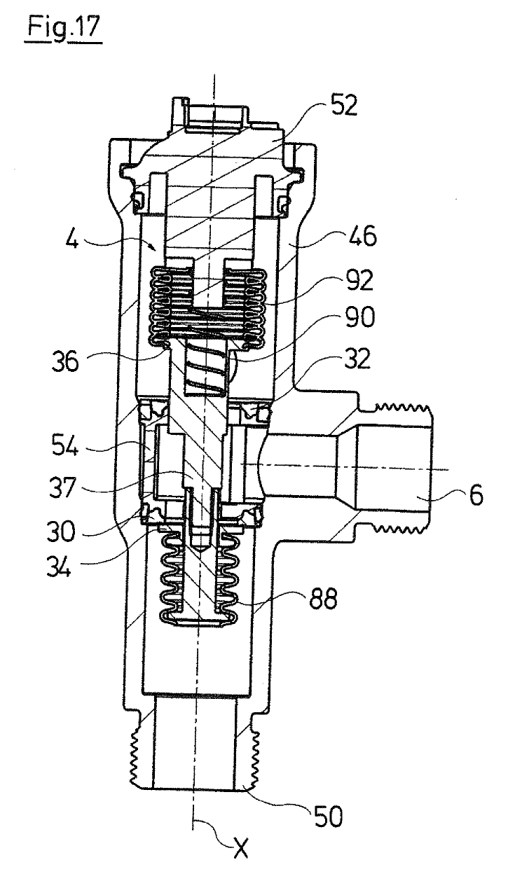

The embodiment example according to FIGS. 16 and 17 differs from the embodiment example according to FIGS. 14 and 15 on the one hand by way of the fact that in the idle position which is shown in FIG. 16 and which corresponds to the first switch position, the valve element 36 bears on its sealing seat 32, whereas the valve element 34 is lifted from the valve seat 30. This means that the circuit across the secondary heat exchanger 16 is open in this starting position as is described by way of FIGS. 1 to 4, whereas the flow path through the heating circuit is opened in the first switch position with the embodiment example according to FIGS. 14 and 15. Moreover, with the embodiment example according to FIGS. 16 and 17, the valve element 34 is connected to the connection element 37 via a bellows 88 which corresponds to the bellows 86. The bellows 88 also serves as a damper when the valve element 34 abuts on the valve seat 30. The connection element 37 and the valve element 36 can move still further whilst the valve element 34 already closes the valve seat 30. The valve element 36 is moreover supported on the closure 52 via a spring 90 which with regard to its function corresponds to the spring 82 in FIGS. 14 and 15. A further bellows 92 is arranged in a manner surrounding the spring 90 and is arranged between the closure 52 and the valve element 36 and serves as a further damper. The bellows 92 likewise comprises an opening which acts as a throttle location and which for example can be formed in the contact region to the valve element 36. With this embodiment, the valve element 36 is held on the valve seat 32 by way of the pressure prevailing at the second entry 24, as long as the pump assembly 2 is operated in the first operating condition at a higher speed. If this holding force is reduced by way of reducing the speed of the pump assembly 2 in a second operating condition, then the self-holding condition is lifted and the valve element 34 is pulled against the valve seat 30 by way of the flow energy which is still present in the fluid. This means that the to and fro movement of the switching elements in the form of valve elements 34 and 36 sets in. The abutment is thereby damped via the bellows 88 and 92. Then, by way of punctual restarting operation of the pump assembly into the first operating condition, an adequate holding pressure acts upon the valve element 34, so that again a self-holding effect is achieved in the second switch position. Otherwise, the valve elements 34 and 36 are moved by the spring 90 again into their first switch position.

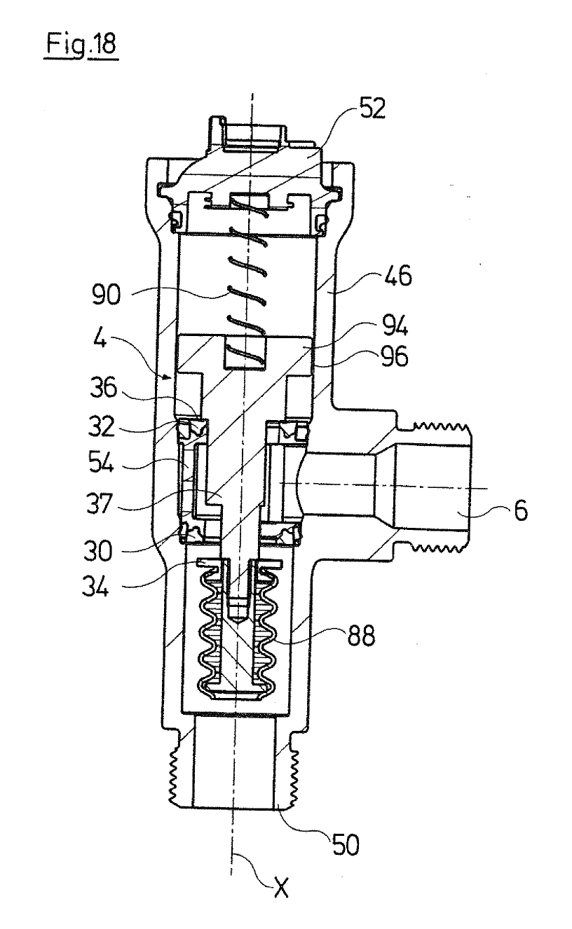

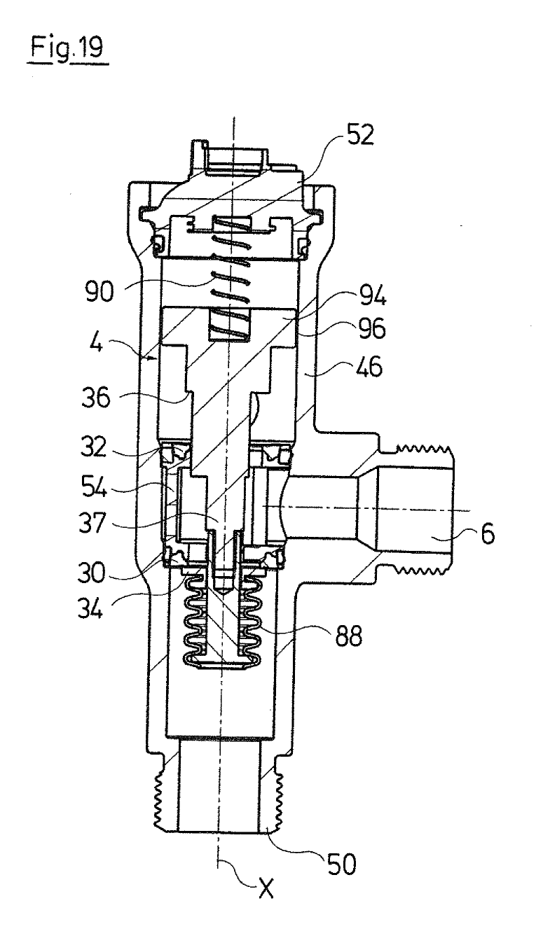

The embodiment example according to FIGS. 18 and 19 differs from the embodiment examples according to FIGS. 16 and 17 by way of the fact that the bellows 92 is done away with and a plunger 94 is integrally formed on the valve element 36 instead, wherein this plunger is movable in the housing 46 in the axial direction X. An annular gap 96 which acts as a throttle location is formed between the peripheral wall of the plunger 94 and the inner wall of the housing 46. This throttle location leads to a damping given the movement of the plunger 94, since the fluid must flow through the annular gap 96 from the one side to the other side of the piston 94. Thus, the plunger 94 with the annular gap 96 assumes the function of the previously described bellows 92. The manner of functioning of the switching device according to FIGS. 18 and 19 is otherwise the same as is described by way of FIGS. 16 and 17.

The pump assembly 2 is preferably configured as a pump assembly with an electric drive motor which is activated via a frequency converter. The use of such an activation has the advantage that the pump assembly 2 can be additionally braked by opposing magnetic fields on reducing the rotational speed. A more rapid speed reduction is therefore achieved. The applied bags or bellows 40, 58, 86, 88 and 92 are preferably manufactured of rubber or a suitable elastomer.

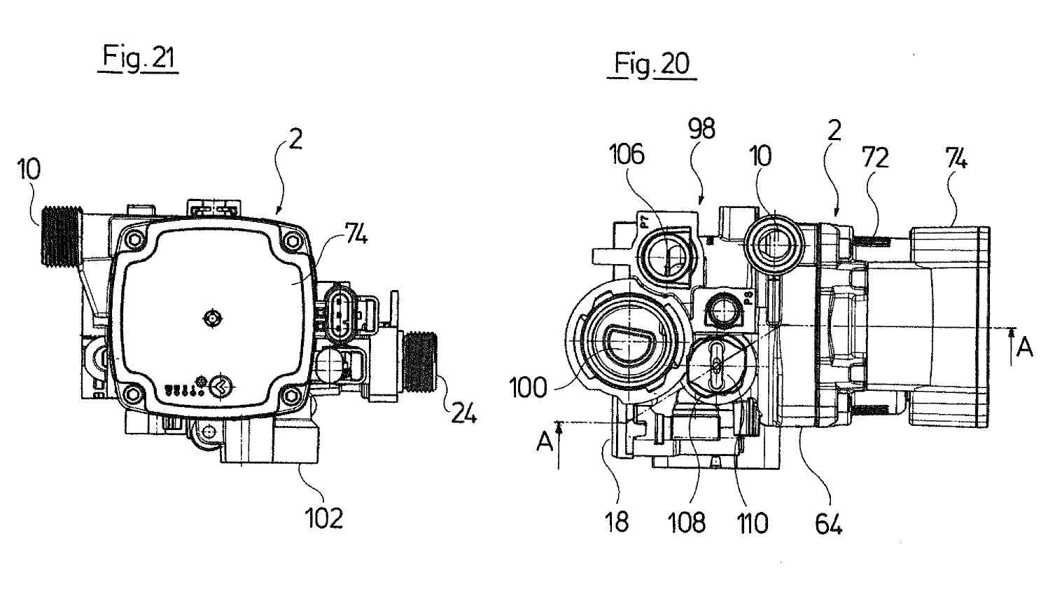

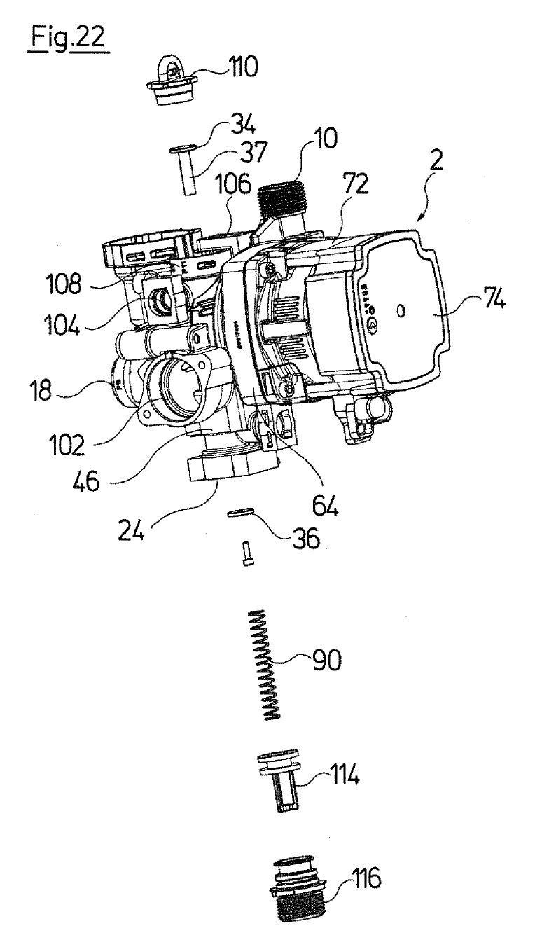

FIGS. 20 to 25 by way of example show the integration of a switching device according to the invention into a hydraulic block for a heating facility. Herein, it is to be understood that switching devices, as have been described beforehand, can likewise be integrated into such a hydraulic block in a corresponding manner. The hydraulic block forms an integrated construction unit which can be integrated into a heating facility, in particular into a compact heating facility. This hydraulic construction unit groups together different hydraulic elements of a heating facility and creates the necessary hydraulic connections in its inside.

The shown hydraulic block as an essential component comprises a pump assembly 2. This pump assembly 2 comprises a motor housing 72 with the electrical drive motor 70 which is arranged therein as well as an electronics housing 74 which is attached at the axial side and in which the control device 28 is arranged. The pump casing 64 of the pump assembly 2 is an integral constituent of the hydraulic block 98 which furthermore comprises further hydraulic flow paths and components. In particular, a switching device 4 according to the invention is arranged in the inside of the hydraulic block 98. The switching device 4 here is configured as a switch-over device which switches over the hydraulic flow path between a secondary heat exchanger 16 and a heating circuit through the radiator 20, as has basically been described by way of FIGS. 1 to 4.

The hydraulic block 98 comprises a first inlet 18 or first connection 18 which here is formed for the direct connection to the secondary heat exchanger 16. The first inlet 18 bears on the rear side of the hydraulic block 98, whilst the pump assembly 2 is situated at the front side. The envisaged installation position of the hydraulic block 98 in a heating facility is thereby such that the rotation axis of the pump assembly 2 extends horizontally. The hydraulic block 98 further comprises a second inlet 24 which is configured for connection to a heating circuit through the radiator 20 (see preceding description). The second inlet 24 here is configured as a threaded connection which extends downwards in the envisaged installation position. This is preferred since the conduit connections for the external pipework are preferably directed downwards in the case of common hydraulic blocks for heating facilities, in particular compact heating facilities. The hydraulic block 98 moreover comprises a delivery-side connection 10 which is provided for connection to the aforementioned primary heat exchanger 12 and in the pump casing 64 is connected to the delivery side of the pump assembly 2. The hydraulic block 98 further comprises yet an end-vent receiver 100, in which an end-vent which is not shown is inserted. Furthermore, further opening as assembly openings and receivers are provided for sensors, such as for example the assembly opening 102 which permits an access to the switching device 4 for maintenance and assembly purposes. The openings 104 and 106 function for example as receivers for pressure and/or temperature sensors.

The switching device 4 in the embodiment according to FIGS. 20 to 25 is configured such that the fluid which flows in the facility or the liquid which flows in the facility serves as an energy store. This means that the kinetic energy of the liquid is utilized for switching over the switching device. The switching device in this embodiment example also comprises two valve elements 34 and 36 which are connected to one another via a connection element 37. The switching device 4 furthermore comprises a spring 90 which acts as a restoring spring and which with regard to its function corresponds to the spring 90 which is described by way of FIGS. 18 and 19.

In this embodiment example, the housing 46 of the switching device 4 is likewise integrated into the hydraulic block 98 and in particular is configured as one piece with the pump casing 64 and the connecting flows paths to the inlets 18 and 24. A connection space 38 which is connected to the suction side or to a suction connection in the pump casing 64 and thus forms a suction-side flow path to the impeller 68 is situated in the housing 46. The connection of the connection space 38 into the pump casing 64 with regard to its function corresponds to the outlet 6 in the embodiment example according to FIGS. 18 and 19. Two valve seats 30 and 32 which are away from one another are situated on the connection space 38. The valve element 34 can come into sealing bearing contact on the valve seat 30, whereas the valve element 36 can come into sealing bearing contact on the valve seat 32. The valve seats 30 and 32 in this embodiment are integrally formed with the housing 46, in particular as one piece with this. The valve elements 34 and 36 are assembled through the inlet 24 and an assembly opening 108 which is situated at an opposite end of the housing 46, wherein the assembly opening 108 is subsequently closed by a closure element 110. However, other assembly types are also conceivable, in particular if the valve seats 30 and 32 are likewise configured as an insert, as has been described by way of FIGS. 18 and 19.

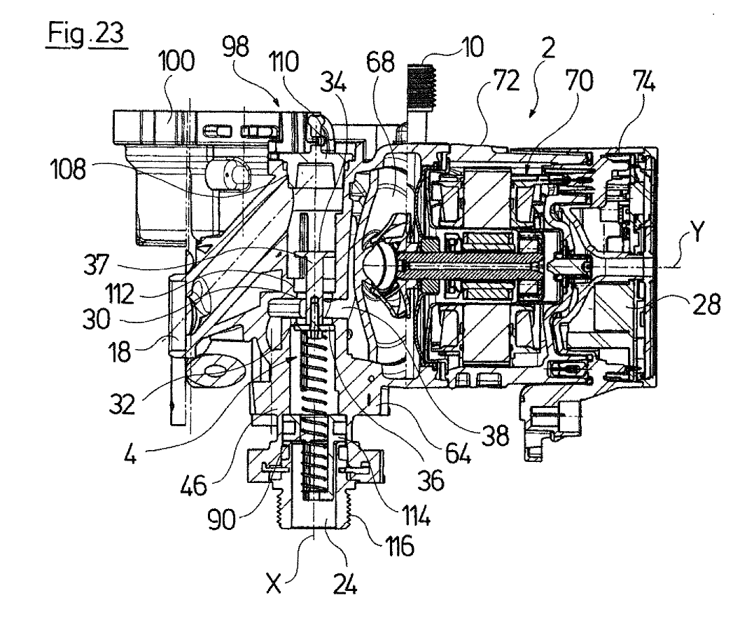

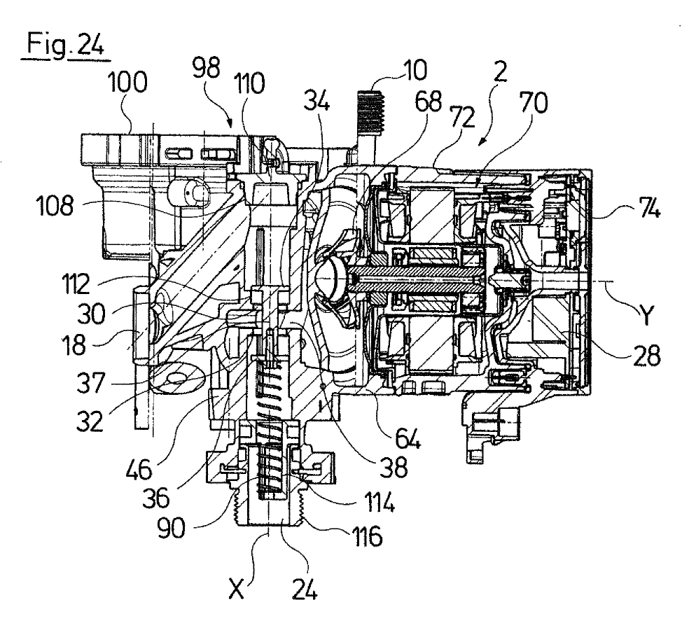

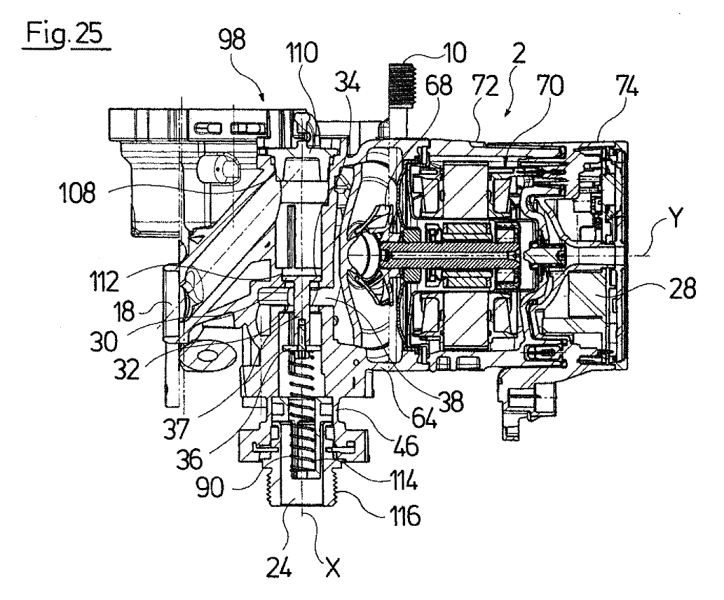

The manner of functioning of the switching device 4 in the embodiment according to FIGS. 20 to 25 corresponds essentially to the functioning manner if the switching device according to FIGS. 18 and 19, which is why the corresponding description is referred to. In contrast to the previously described embodiment example according to FIGS. 18 and 19, with this example the bellows 88 and the piston 94 are done away with. In this embodiment example in fact, a damping device is achieved by way of the valve element 34 itself acting as a piston which towards the end of its movement path immerses into a narrowing 112 which is adjacent to a valve seat 30, as is shown in FIGS. 24 and 2. The narrow location 112 is configured cylindrically to the longitudinal axis X of the switching device 4 and has a peripheral contour which with regard to its shape corresponds to the peripheral contour of the valve element 34, which is to say in particular is circular. If the valve element 34 is moved towards the valve seat 30 by the kinetic energy of the flow after switching the pump assembly 2 into its second operating condition, then after a certain path the valve element 34 immerses into the narrowing 112, as is shown in FIG. 24. By way of this, the flow path through the valve seat 30 is already essentially closed and one succeeds in the pressure at the node point 14 (see FIGS. 1 to 4) now acting upon the valve element 34 and then pressing this further onto the valve seat 30 on switching again into the first operating condition of the pump assembly, as is shown in FIG. 25. A damping of the movement of the valve element 34 with the connection element 37 and the valve element 36 is achieved by the described narrowing, and this prevents the rebound of the valve element 34 from the valve seat 30. If the valve element 34 enters into the narrowing 112, then the flow path through the associated valve seat 30 is already essentially closed, and the valve element 34 and the connection element 37 with the further valve element 36, despite this, can move further by a certain amount, by which means the rebounding is prevented. If now the pump assembly is switched back again into the first operating condition whilst the flow path through the valve seat 30 is essentially closed, then the valve element 34 remains in this switch position, with the valve element 34 in bearing contact on the valve seat 30. If the pump assembly is subsequently switched back into the second operating condition, the pressure at the node point 14 reduces again to such an extent that the spring 90 moves the valve elements 34 and 36 back again into the first switch position which is shown in FIG. 23. This switch position corresponds to the idle position. The spring is supported on a spring carrier 114 which is fixed on the inlet 24 by a threaded insert 116 in the housing 46.

While specific embodiments of the invention have been shown and described in detail to illustrate the application of the principles of the invention, it will be understood that the invention may be embodied otherwise without departing from such principles.

1. A method for switching a switching device between two switch positions in a hydraulic system, wherein the hydraulic system apart from the switching device comprises a pump assembly, the method comprising the steps of:
providing the pump assembly such that the pump assembly assumes at least two different operating conditions and such that a switching-over of the switching device is initiated by the pump assembly via the hydraulic system; and
reaching the switch positions of the switching device in dependance on a stay duration of the pump assembly in at least one of the two operating conditions.

2. A method according to claim 1, wherein:
the switching device is self-holding in each of the two switch positions, on operation of the pump assembly in a first operating condition;
the pump assembly is brought out of the first operating condition into a second operating condition for switching over between the switch positions;
the switching device is switched to and fro between the two switch positions, when the pump assembly is situated in the second operating condition; and
the pump assembly is brought again into the first operating condition on reaching a desired switch position, for holding the desired switch position.

3. A method according to claim 1, wherein:
the pump assembly is operated at a higher speed in a first operating condition than in the second operating condition;
the speed in the first operating condition is greater than a predefined limit speed and in the second operating condition the speed is smaller or equal to the limit speed, or the pump assembly is at a standstill in the second operating condition.

4. A method according to claim 1, wherein the switching device in the first operating condition is held in the respective switch position by a hydraulic force produced by the pump assembly.

5. A method according to claim 1, wherein the switching device is moved into a defined starting position and held there, on operation of the pump assembly in the second operating condition or with a standstill of the pump assembly or on operation of the pump assembly in the second operating condition and with a standstill of the pump assembly.

6. A method according to claim 2, wherein each of the two switch positions is assumed at least once by the switching device, with the to and fro switching of the switching device.

7. A method according to claim 2, wherein the to and fro switching of the switching device is effected with assistance of energy which was previously stored in at least one energy store or in the hydraulic system or previously stored in at least one energy store and in the hydraulic system, on operation of the pump assembly in the first operating condition, or is released to the hydraulic system by the pump assembly in the second operating condition.

8. A method according to claim 2, wherein a movement between the two switch positions of the switching device on switching to and fro is delayed via at least one damping element or a path distance to be covered or by both at least one damping element and a path distance to be covered.

9. A method according to claim 1, wherein
the switching device is a switch-over device which switches between two flow paths for a flow produced by the pump assembly;
a hydraulic pressure which is produced by the pump assembly in the just closed flow path is utilized to hold the switching device in an assumed switch position, as long as the pump assembly is operated in the first operating condition.

10. A hydraulic system comprising:
at least one pump assembly having at least two different operating conditions;
a hydraulic connection; and
a switching device which comprises two switch positions, wherein the switching device is connected to the pump assembly via the hydraulic connection and is configured such that the switch positions of the switching device are reached depending on a stay duration of the pump assembly in at least one of the two operating conditions.

11. A hydraulic system according to claim 10, wherein the switching device has two switch positions and is configured such that the switching device is self-holding in each of the two switch positions on operation of the pump assembly in a first operating condition, and that the pump assembly as well as the switching device are configured such that for switching over between the switch positions, they the pump assembly and the switching device interact such that in a second operating condition of the pump assembly, the switching device switches to and fro between the two switch positions, and on reaching a desired switch position, the pump assembly is brought into the first operating condition, for holding the desired switch position.

12. A hydraulic system according to claim 10, wherein the pump assembly is configured such that the pump assembly is operated at a speed above a limit speed in the first operating condition, and that the pump assembly is operated at a speed which is smaller or equal to the limit speed or is at a standstill, in the second operating condition.

13. A hydraulic system according to claim 10, wherein the switching device is provided with a drive element which in the second operating condition of the pump assembly switches the switching device to and fro between the two switch positions.

14. A hydraulic system according to claim 13, wherein drive element is configured such that the drive element is movable by a force, which is caused by a hydraulic inertia force in the hydraulic system or by an energy store which is configured such that the energy store stores energy from the hydraulic system on operation of the pump assembly or by both a hydraulic inertia force in the hydraulic system by an energy store which is configured such that the energy store stores energy from the hydraulic system on operation of the pump assembly, in the first operating condition, and releases energy on operation of the pump assembly in the second operating condition, by way of which energy the switching device is moved.

15. A hydraulic system according to claim 10, wherein the switching device is configured such that on operation of the pump assembly in the second operating condition, the switching device switches at least once into each of the two switch positions.

16. A hydraulic system according to claim 10, wherein the switching device comprises a restoring element which is configured such the switching of the switching device to and fro ends in a defined starting position of the switching device and holds the switching device in this defined starting position on standstill of the pump assembly.

17. A hydraulic system according to claim 10, further comprising a control device which configured to firstly bring the pump assembly out of the first operating condition into the second operating condition on the basis of a switching command for switching over the switching device from the first into the second switch position, and to bring the pump assembly back again into the first operating condition after a defined time interval which is matched to the time duration of the to and fro movement of the switching device such that the switching device is situated in the second switch position when the pump assembly is brought again into the first operating condition.

18. A hydraulic system according to claim 10, wherein:
the pump assembly comprises a speed controller for changing the speed of the pump assembly; and
the speed controller comprises a braking circuit which actively brakes the pump assembly given a reduction of the speed.

19. A hydraulic system according to claim 10, wherein the switching device comprises at least one damping device which acts such that a direct impact of the switching device on reaching at least one of the two switch positions is prevented.

20. A hydraulic system according to claim 10, wherein the switching device comprises at least one linearly movable valve body which, in one switch position, sealingly bears on an associated valve seat and is configured such that the valve body, with movement thereof, passes an annular wall which surrounds the outer periphery of the valve body and which reduces the flow cross section, before reaching the valve seat.

21. A hydraulic system according to claim 10, wherein that the switching device together with the at least one pump assembly is integrated into a hydraulic block for a heating facility.
